(19) United States
(12) Patent Application Publication
(10) Pub. No.: US 2022/0156508 A1
(43) Pub. Date: May 19, 2022

(54) Method For Automatically Designing Efficient Hardware-Aware Neural Networks For Visual Recognition Using Knowledge Distillation

(71) Applicant: QUALCOMM Incorporated, San Diego, CA (US)

(72) Inventors: Bert MOONS, Antwerpen (BE); Parham NOORZAD, San Diego, CA (US); Andrii SKLIAR, Diemen (NL); Christopher LOTT, San Diego, CA (US); Tijmen Pieter Frederik BLANKEVOORT, Amsterdam (NL)

(21) Appl. No.: 17/455,201

(22) Filed: Nov. 16, 2021

Related U.S. Application Data
(60) Provisional application No. 63/114,463, filed on Nov. 16, 2020.

(51) Int. Cl. G06K 9/62; G06N 3/08

(52) U.S. Cl. CPC G06K 9/6227; G06N 3/08; G06K 9/6262

(57) ABSTRACT

Various aspects provide methods for a computing device selecting a neural network for a hardware configuration including using an accuracy predictor to select from a search space a neural network including a first plurality of the blockwise knowledge distillation trained search blocks, in which the accuracy predictor is built using search space trained blockwise knowledge distillation search blocks. Aspects may include selecting a second plurality of the blockwise knowledge distillation trained search blocks based on criteria of predicted accuracy using the accuracy predictor for the second plurality of the blockwise knowledge distillation trained search blocks. Aspects may include selecting the neural network based on a search of the blockwise knowledge distillation trained search blocks, initializing the blockwise knowledge distillation trained search blocks of the neural network using weights of the blockwise knowledge distillation trained search blocks, and fine-tuning the neural network using knowledge distillation, to generate a distilled neural network.

### RELATED APPLICATIONS

This application claims the benefit of priority to U.S. Provisional Patent Application No. 63/114,463 entitled “A Method For Automatically Designing Efficient Hardware-Aware Neural Networks For Visual Recognition Using Knowledge Distillation” filed Nov. 16, 2020, the entire contents of which are incorporated herein by reference for all purposes.

### BACKGROUND

Energy-efficiency of artificial intelligence (AI) workloads, such as running neural networks for visual recognition, is key for mobile and automotive hardware platforms. However, hand-optimizing efficient on-platform neural networks is prohibitively time and resource consuming. In this process, a trained engineer will first select a neural network(s) from experience, among trillions of architectural options. Then, the selected neural network(s) will be trained from scratch, requiring around 400-500 GPU-hours each to complete the design process. When the trained neural network does not achieve its efficiency targets, typically a set quality level (e.g., classification accuracy) for a fixed hardware metric (e.g., latency on a platform), or whenever driver software or hardware platform changes, the process has to be repeated.

### SUMMARY

Various aspects of the disclosure provide methods executable on a computing device for selecting a neural network. Various aspects include using an accuracy predictor to select from a search space a neural network comprising a first plurality of the blockwise knowledge distillation trained search blocks, in which the accuracy predictor is built using blockwise knowledge distillation trained search blocks that were trained from the search space.

Various aspects may include selecting a second plurality of the blockwise knowledge distillation trained search blocks based on criteria of predicted accuracy using the accuracy predictor and a cost function for implementing the second plurality of the blockwise knowledge distillation trained search blocks.

In some aspects, selecting the second plurality of the blockwise knowledge distillation trained search blocks may include using an evolutionary search to select the second plurality of the blockwise knowledge distillation trained search blocks.

In some aspects, the second plurality of the blockwise knowledge distillation trained search blocks are Pareto-optimal blockwise knowledge distillation trained search blocks.

In some aspects, using the accuracy predictor to select from the search space the neural network may include selecting the first plurality of the blockwise knowledge distillation trained search blocks using a scenario-aware search to select the first plurality of the blockwise knowledge distillation trained search blocks.

Some aspects may include initializing the first plurality of the blockwise knowledge distillation trained search blocks using weights of the blockwise knowledge distillation trained search blocks and fine-tuning the neural network using knowledge distillation.

Some aspects may include selecting a sub-set of neural networks of the search space, in which each neural network of the sub-set of neural networks may include blockwise knowledge distillation trained search blocks of the generated blockwise knowledge distillation trained search blocks; initializing the blockwise knowledge distillation trained search blocks of the sub-set of neural networks using weights of the blockwise knowledge distillation trained search blocks, and fine-tuning the sub-set of neural networks using knowledge distillation.

Some aspects may include extracting a quality metric by using blockwise knowledge distillation to train the neural network blocks from the search space and extracting a target by fine-tuning the sub-set of neural networks using knowledge distillation, in which the accuracy predictor is built using a linear regression model from the quality metric to the target.

In some aspects, using the accuracy predictor to select from the search space the neural network may include selecting the neural network of the search space based on a search of the blockwise knowledge distillation trained search blocks using a criterion of predicted accuracy using the accuracy predictor and a cost function for implementing blockwise knowledge distillation trained search blocks of the neural network, and such aspects may further include initializing the second plurality of the blockwise knowledge distillation trained search blocks using weights of the blockwise knowledge distillation trained search blocks, and fine-tuning the neural network using knowledge distillation, to generate a distilled neural network.

Some aspects may include using blockwise knowledge distillation to train neural network blocks from an extended search space to generate blockwise knowledge distillation trained search blocks and quality metrics, using the accuracy predictor to predict accuracy of the extended search space, in which the accuracy predictor is built for the search space different from the extended search space.

Further aspects include a computing device including a processor configured with processor-executable instructions to perform operations of any of the methods summarized above. Further aspects include a non-transitory processor-readable storage medium having stored thereon processor-executable software instructions configured to cause a processor to perform operations of any of the methods summarized above. Further aspects include a computing device having means for accomplishing functions of any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIGS. 1A and 1B are functionality component block diagrams illustrating an example software implemented neural network that could benefit from implementing the embodiments.

FIG. 2 is a functionality component block diagram illustrating interactions between functionality components in an example perceptron neural network that could benefit from implementing the embodiments.

FIGS. 3A and 3B are functionality component block diagrams illustrating interactions between functionality components in an example convolutional neural network that could be configured to implement a generalized framework to accomplish continual learning in accordance with various embodiments.

FIG. 4 is a graph diagram illustrating search duration for distilling neural network architectures for any number of use-cases in accordance with various embodiments.

FIG. 5 is a block diagram illustrating an example reference neural network defined in a search-space for distilling neural network architectures in accordance with various embodiments.

FIG. 6 is a process flow diagram illustrating a method of defining a search-space for distilling neural network architectures in accordance with various embodiments.

FIGS. 7A-7F are block, table, and function diagrams illustrating structures and functions for generating an accuracy model using blockwise knowledge distillation for distilling neural network architectures in accordance with various embodiments.

FIG. 8 is a process flow diagram illustrating a method of generating an accuracy model using blockwise knowledge distillation for distilling neural network architectures in accordance with various embodiments.

FIG. 9 is a process flow and graph diagram illustrating searching for a neural network architecture from a search-space for distilling neural network architectures in accordance with various embodiments.

FIG. 10 is a process flow diagram illustrating a method of searching for a neural network architecture from a search-space for distilling neural network architectures in accordance with various embodiments.

FIG. 11 is a block and function diagram illustrating fine-tuning a neural network architecture from a search-space for distilling neural network architectures in accordance with various embodiments.

FIG. 12 is a process flow diagram illustrating a method for fine-tuning a neural network architecture from a search-space for distilling neural network architectures in accordance with various embodiments.

FIGS. 13A-13C are process flow diagrams illustrating methods for applying a distilled neural network architecture from a search-space to a downstream task in accordance with various embodiments.

FIG. 14 is a process flow diagram illustrating a method for applying a distilled neural network architecture from a search-space to a downstream task in accordance with various embodiments.

FIG. 15 is a structure and function flow diagram illustrating applying a distilled neural network architecture from a search-space to a downstream task in accordance with various embodiments.

FIG. 16 is a structure and function flow diagram illustrating applying a distilled neural network architecture from a search-space for refining a trained neural network in accordance with various embodiments.

FIG. 17 is a component block diagram of a server suitable for use with the various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments provide methods for selecting a neural network architecture suitable for a hardware configuration. Various embodiments may include using an accuracy predictor to select from a search space a neural network comprising a first plurality of the blockwise knowledge distillation trained search blocks. Various embodiments may include building the accuracy predictor using blockwise knowledge distillation trained search blocks that were trained from the search space. Various embodiments may include implementing a search for identifying knowledge distillation trained neural network blocks from the search space based on predicted accuracy and any number and combination of cost functions for the search blocks. Various embodiments may include fine-tuning a neural network made of knowledge distillation trained neural network blocks from the search space selected based on the search and using to generate a distilled neural network. In various embodiments, fine-tuning the neural network use weights initialized from the knowledge distillation training of the neural network blocks from the search space. In various embodiments, fine-tuning the neural network use knowledge distillation to fine-tuning the neural network.

The term “computing device” is used herein to refer to any one or all of servers, personal computers, mobile device, cellular telephones, smartphones, portable computing devices, personal or mobile multi-media players, personal data assistants (PDA's), laptop computers, tablet computers, smartbooks, IoT devices, palm-top computers, wireless electronic mail receivers, multimedia Internet enabled cellular telephones, connected vehicles, wireless gaming controllers, and similar electronic devices that include a memory and a programmable processor.

The term “neural network” is used herein to refer to an interconnected group of processing nodes (e.g., neuron models, etc.) that collectively operate as a software application or process that controls a function of a computing device or generates a neural network inference. Individual nodes in a neural network may attempt to emulate biological neurons by receiving input data, performing simple operations on the input data to generate output data, and passing the output data (also called “activation”) to the next node in the network. Each node may be associated with a weight value that defines or governs the relationship between input data and activation. The weight values may be determined during a training phase and iteratively updated as data flows through the neural network.

Deep neural networks implement a layered architecture in which the activation of a first layer of nodes becomes an input to a second layer of nodes, the activation of a second layer of nodes becomes an input to a third layer of nodes, and so on. As such, computations in a deep neural network may be distributed over a population of processing nodes that make up a computational chain. Deep neural networks may also include activation functions and sub-functions (e.g., a rectified linear unit that cuts off activations below zero, etc.) between the layers. The first layer of nodes of a deep neural network may be referred to as an input layer. The final layer of nodes may be referred to as an output layer. The layers in-between the input and final layer may be referred to as intermediate layers, hidden layers, or black-box layers.

Each layer in a neural network may have multiple inputs, and thus multiple previous or preceding layers. Said another way, multiple layers may feed into a single layer. For ease of reference, some of the embodiments are described with reference to a single input or single preceding layer. However, it should be understood that the operations disclosed and described in this application may be applied to each of multiple inputs to a layer as well as multiple preceding layers.

Hand-optimizing efficient on-platform neural networks is prohibitively time and resource consuming, requiring a trained engineer to select a neural network(s) based on experience, from among trillions of architectural options. The selected neural network(s) must be trained from scratch, requiring around 400-500 GPU-hours each to complete the design process. When the trained neural network does not achieve its efficiency targets, typically a set quality level (e.g., classification accuracy) for a fixed hardware metric (e.g., latency on a platform), or whenever driver software or hardware platform changes, the process has to be repeated.

Neural architecture search methods (NAS) are used to help alleviate the costs associated with hand-optimize efficient op-platform neural networks. However existing NAS methods are either: (a) still too expensive in terms of resources, (b) have limitations on the types of architectures they can search for, or (c) cannot be used to optimally design for modern hardware platforms directly.

The embodiments described herein may provide improvements on the high cost of hand-optimizing efficient on-platform neural networks, and improvements on the limitations of existing NAS methods, by automating the design process for a wide and diverse set of potential neural network architectures and hardware platforms and by making the design process less resource intensive. Some embodiments may reduce the resource requirements of designing energy efficient on-platform neural networks both in terms of man-hours and compute costs. These reductions in resource requirements may be achieved by (1) a novel way to build accuracy models for a diverse search space of candidate neural network architectures with a variety of cell-types. Blockwise knowledge distillation may be implemented to build accuracy models from a diverse neural network architectural search space. Using blockwise knowledge distillation may allow for cheap modeling of the accuracy of neural networks with varying micro-architectures (network-depths, kernel-sizes and expansion-rates), and also across varying macro-architectures (cell-types, attention-mechanisms, activation functions and channel-widths), which is not a feature of existing NAS methods. In addition, the accuracy models may allow for better prediction of the ranking of neural network architectures than existing NAS methods.

Some embodiments may further include (2) a quick evolutionary search-phase extracting a front of architectures in terms of accuracy and some on-target efficiency metric (e.g., number of operations, latency, energy consumption, etc.), such as a Pareto-optimal front. The evolutionary search may be performed using the prior accuracy model together with hardware measurements in the loop and may be repeated quickly many times, amortizing the resource-costs of building the accuracy model. A brief search phase may find latency-accuracy Pareto-optimal neural network architectures for any use-case or hardware platform by running a 2D-optimization algorithm using the accuracy model together with hardware measurements in the loop, which may be quickly rerun whenever anything changes to a use-case, hardware platform, or platform software version.

Some embodiments may further include that (3) the way the accuracy model is built in (1) may allow fine-tuning of any neural network in a search space quickly, up to full accuracy. This may be 9 to 30 times faster than training the neural network from scratch.

The embodiments described herein may be scalable for use in multiple use-case, for multiple hardware configurations, or multiple platform software configurations. The upfront costs of building an accuracy model by performing blockwise knowledge distillation, which requires training partial neural networks (blocks) may be amortized by the ability to reuse the accuracy model multiple times for various circumstances. Using a built accuracy model, the cost of a search scales linearly with the number of different use-cases, multiple hardware configurations, or multiple platform software configurations to which the accuracy model is applied to find efficient neural networks. The embodiments described herein may be highly parallelized, such that the embodiments can adapt to a resource budget of any number of processors (e.g., GPUs), as opposed to existing NAS methods that can only scale up their compute to certain practical maximum numbers of GPUs before training can become unstable.

In some embodiments, the neural network designed using an accuracy model, evolutionary search, and fine-tuning may also be applicable to downstream tasks. For example, the designed neural network may be an image classification neural network and may be applicable for use in computer vision tasks, such as object detection, semantic segmentation models, super-resolution models, video classification, video segmentation, etc. In some embodiments, the designed neural network may be applicable to downstream tasks through reusing designed classification networks as a reference. In some embodiments, the designed neural network may be applicable to downstream tasks through performing a search directly on a downstream neural network.

In some embodiments, the neural network designed using an accuracy model, evolutionary search, and fine-tuning may also be applicable to designing, compressing, improving, and/or selecting hardware for other neural networks.

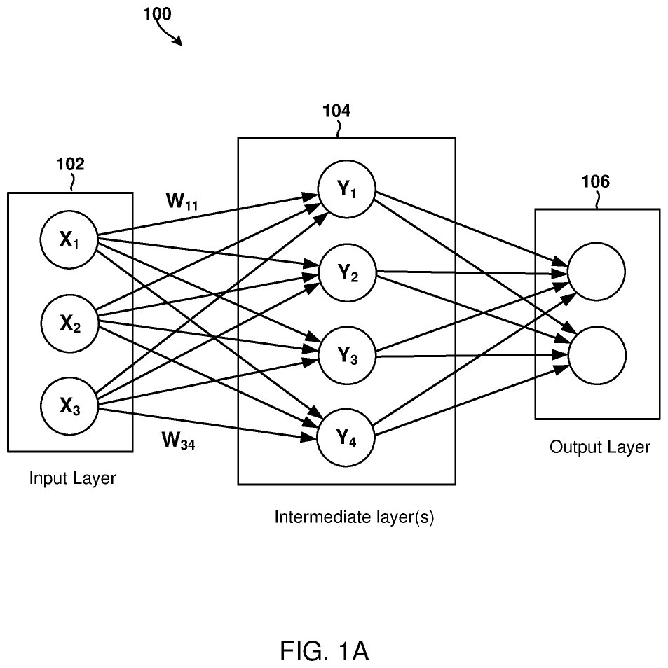

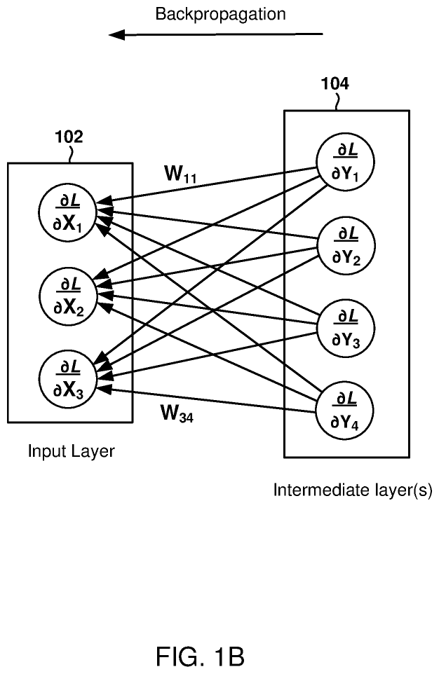

FIGS. 1A and 1B illustrate an example neural network 100 that could be implemented in a computing device, and which could benefit from implementing the embodiments. With reference to FIG. 1A, the neural network 100 may include an input layer 102, intermediate layer(s) 104, and an output layer 106. Each of the layers 102, 104, 106 may include one or more processing nodes that receive input values, perform computations based the input values, and propagate the result (activation) to the next layer.

In feed-forward neural networks, such as the neural network 100 illustrated in FIG. 1A, all of the computations are performed as a sequence of operations on the outputs of a previous layer. The final set of operations generate the output of the neural network, such as a probability that an image contains a specific item (e.g., dog, cat, etc.) or information indicating that a proposed action should be taken. The final output of the neural network may correspond to a task that the neural network 100 may be performing, such as determining whether an image contains a specific item (e.g., dog, cat, etc.). Many neural networks 100 are stateless. The output for an input is always the same irrespective of the sequence of inputs previously processed by the neural network 100.

The neural network 100 illustrated in FIG. 1A includes fully-connected (FC) layers, which are also sometimes referred to as multi-layer perceptrons (MLPs). In a fully-connected layer, all outputs are connected to all inputs. Each processing node's activation is computed as a weighted sum of all the inputs received from the previous layer.

An example computation performed by the processing nodes and/or neural network 100 may be:

$${y}_{i} = f ( {\sum }_{i = 1}^{3} {W}_{ij} * {x}_{i} + b )$$

in which Wᵢⱼ are weights, xᵢ is the input to the layer, yⱼ is the output activation of the layer, f(•) is a non-linear function, and b is bias, which may vary with each node (e.g., bⱼ). As another example, the neural network 100 may be configured to receive pixels of an image (i.e., input values) in the first layer, and generate outputs indicating the presence of different low-level features (e.g., lines, edges, etc.) in the image. At a subsequent layer, these features may be combined to indicate the likely presence of higher-level features. For example, in training of a neural network for image recognition, lines may be combined into shapes, shapes may be combined into sets of shapes, etc., and at the output layer, the neural network 100 may generate a probability value that indicates whether a particular object is present in the image.

The neural network 100 may learn to perform new tasks over time. However, the overall structure of the neural network 100, and operations of the processing nodes, do not change as the neural network learns the task. Rather, learning is accomplished during a training process in which the values of the weights and bias of each layer are determined. After the training process is complete, the neural network 100 may begin “inference” to process a new task with the determined weights and bias.

Training the neural network 100 may include causing the neural network 100 to process a task for which an expected/desired output is known, and comparing the output generated by the neural network 100 to the expected/desired output. The difference between the expected/desired output and the output generated by the neural network 100 is referred to as loss (L).

During training, the weights (wᵢⱼ) may be updated using a hill-climbing optimization process called “gradient descent.” This gradient indicates how the weights should change in order to reduce loss (L). A multiple of the gradient of the loss relative to each weight, which may be the partial derivative of the loss

$$( e . g , \frac{\partial L}{\partial X 1} , \frac{\partial L}{\partial X 2} , \frac{\partial L}{\partial X 3} )$$

with respect to the weight, could be used to update the weights.

An efficient way to compute the partial derivatives of the gradient is through a process called backpropagation, an example of which is illustrated in FIG. 1B. With reference to FIGS. 1A and 1B, backpropagation may operate by passing values backwards through the network to compute how the loss is affected by each weight. The backpropagation computations may be similar to the computations used when traversing the neural network 100 in the forward direction (i.e., during inference). To improve performance, the loss (L) from multiple sets of input data (“a batch”) may be collected and used in a single pass of updating the weights. Many passes may be required to train the neural network 100 with weights suitable for use during inference (e.g., at runtime or during execution of a software application program).

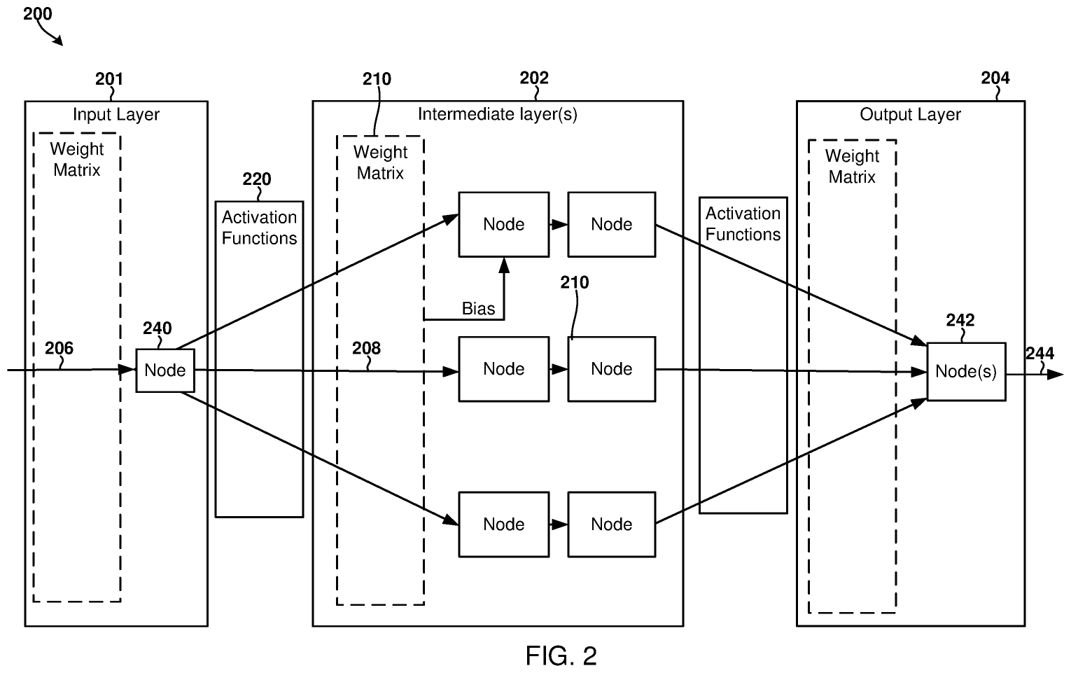

FIG. 2 illustrates interactions between functionality components in another example neural network 200 that could be implemented in a computing device, and which could benefit from the implementation or use of the various embodiments. With reference to FIGS. 1A-2, in the example illustrated in FIG. 2, the neural network 200 is a multilayer perceptron neural network that includes an input layer 201, one or more intermediate layer 202, and an output layer 204. Each of the layers may include one or more nodes 240 that perform operations on the data. In between the layers, there may be various activation functions 220, such as a rectified linear unit (ReLU) that cuts off activations below zero. For ease of reference, and to focus the description on the important features, a layer and its activation functions 220 are sometimes referred to herein collectively as a “layer.”

The input layer 201 may receive and process an input signal 206, generate an activation 208, and pass it to the intermediate layer(s) 202 as black-box inputs. The intermediate layer(s) inputs may multiply the incoming activation with a weight matrix 210 or may apply one or more weight factors and/or a bias to the black-box inputs.

The nodes in the intermediate layer(s) 202 may execute various functions on the inputs augmented with the weight factors and the bias. Intermediate signals may be passed to other nodes or layers within the intermediate layer(s) 202 to produce the intermediate layer(s) activations that are ultimately passed as inputs to the output layer 204. The output layer 204 may include a weighting matrix that further augments each of the received signals with one or more weight factors and bias. The output layer 204 may include a node 242 that operates on the inputs augmented with the weight factors to produce an estimated value 244 as output or neural network inference.

The neural networks 100, 200 described above include fully-connected layers in which all outputs are connected to all inputs, and each processing node's activation is a weighted sum of all the inputs received from the previous layer. In larger neural networks, this may require that the network perform complex computations. The complexity of these computations may be reduced by reducing the number of weights that contribute to the output activation, which may be accomplished by setting the values of select weights to zero. The complexity of these computations may also be reduced by using the same set of weights in the calculation of every output of every processing node in a layer.

Some neural networks may be configured to generate output activations based on convolution. By using convolution, the neural network layer may compute a weighted sum for each output activation using only a small “neighborhood” of inputs (e.g., by setting all other weights beyond the neighborhood to zero, etc.), and share the same set of weights (or filter) for every output. A set of weights is called a filter or kernel. A filter (or kernel) may also be a two- or three-dimensional matrix of weight parameters. In various embodiments, a computing device may implement a filter via a multidimensional array, map, table or any other information structure known in the art.

Generally, a convolutional neural network is a neural network that includes multiple convolution-based layers. The use of convolution in multiple layers allows the neural network to employ a very deep hierarchy of layers. As a result, convolutional neural networks often achieve significantly better performance than neural networks that do not employ convolution.

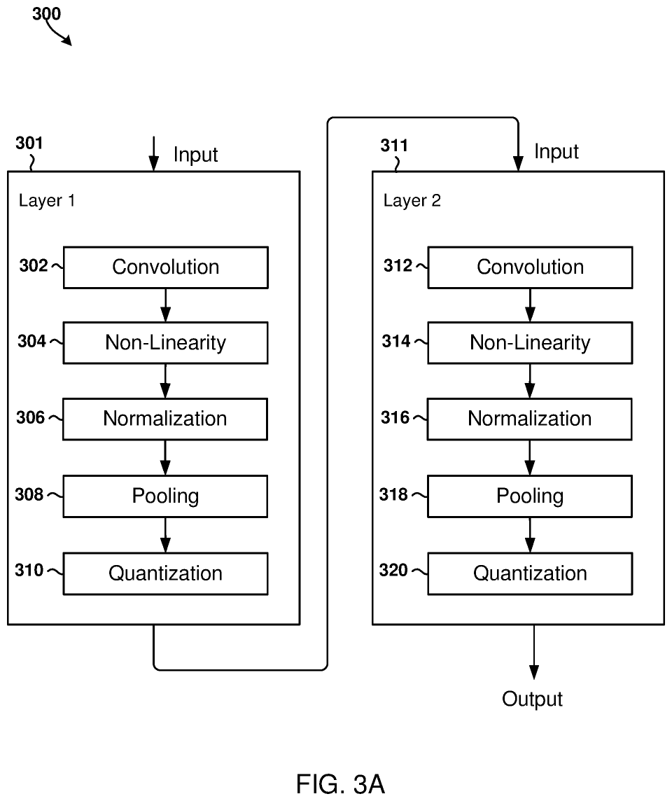

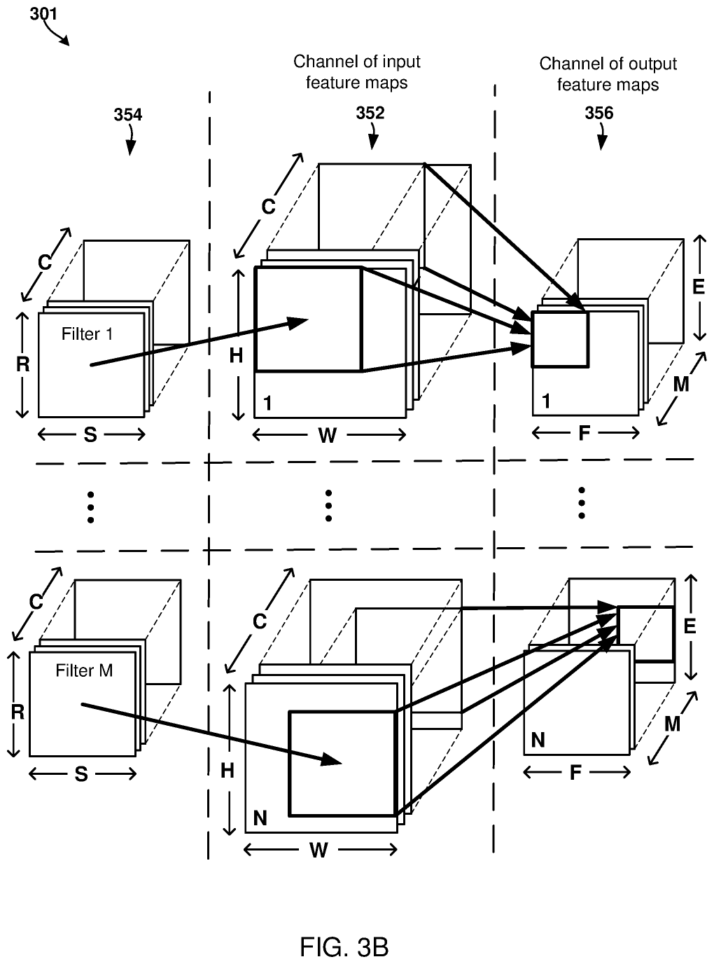

FIGS. 3A and 3B illustrate example functionality components that may be included in a convolutional neural network 300, which could be implemented in a computing device and configured to implement a generalized framework to accomplish continual learning in accordance with various embodiments.

With reference to FIGS. 1-3A, the convolutional neural network 300 may include a first layer 301 and a second layer 311. Each layer 301, 311 may include one or more activation functions. In the example illustrated in FIG. 3A, each layer 301, 311 includes convolution functionality component 302, 312, a non-linearity functionality component 304, 314, a normalization functionality component 306, 316, a pooling functionality component 308, 318, and a quantization functionality component 310, 320. It should be understood that, in various embodiments, the functionality components 302-310 or 312-320 may be implemented as part of a neural network layer, or outside the neural network layer. It should also be understood that the illustrated order of operations in FIG. 3A is merely an example and not intended to limit the various embodiments to any given operation order. In various embodiments, the order and/or inclusion of the operations of functionality components 302-310 or 312-320 may change in any given layer. For example, normalization operations by the normalization functionality component 306, 316 may come after convolution by the convolution functionality component 302, 312 and before non-linearity operations by the non-linearity functionality component 304, 314.

The convolution functionality component 302, 312 may be an activation function for its respective layer 301, 311. The convolution functionality component 302, 312 may be configured to generate a matrix of output activations called a feature map. The feature maps generated in each successive layer 301, 311 typically include values that represent successively higher-level abstractions of input data (e.g., line, shape, object, etc.).

The non-linearity functionality component 304, 314 may be configured to introduce nonlinearity into the output activation of its layer 301, 311. In various embodiments, this may be accomplished via a sigmoid function, a hyperbolic tangent function, a rectified linear unit (ReLU), a leaky ReLU, a parametric ReLU, an exponential LU function, a maxout function, swish, etc.

The normalization functionality component 306, 316 may be configured to control the input distribution across layers to speed up training and the improve accuracy of the outputs or activations. For example, the distribution of the inputs may be normalized to have a zero mean and a unit standard deviation. The normalization function may also use batch normalization (BN) techniques to further scale and shift the values for improved performance.

The pooling functionality components 308, 318 may be configured to reduce the dimensionality of a feature map generated by the convolution functionality component 302, 312 and/or otherwise allow the convolutional neural network 300 to resist small shifts and distortions in values.

With reference to FIGS. 1A-3B, in some embodiments, the inputs to the first layer 301 may be structured as a set of three-dimensional input feature maps 352 that form a channel of input feature maps. In the example illustrated in FIG. 3B, the neural network has a batch size of N three-dimensional feature maps 352 with height H and width W each having C number of channels of input feature maps (illustrated as two-dimensional maps in C channels), and M three-dimensional filters 354 including C filters for each channel (also illustrated as two-dimensional filters for C channels). Applying the 1 to M filters 354 to the 1 to N three-dimensional feature maps 352 results in N output feature maps 356 that include M channels of width F and height E. As illustrated, each channel may be convolved with a three-dimensional filter 354. The results of these convolutions may be summed across all the channels to generate the output activations of the first layer 301 in the form of a channel of output feature maps 356. Additional three-dimensional filters may be applied to the input feature maps 352 to create additional output channels, and multiple input feature maps 352 may be processed together as a batch to improve the reuse of the filter weights. The results of the output channel (e.g., set of output feature maps 356) may be fed to the second layer 311 in the convolutional neural network 300 for further processing.

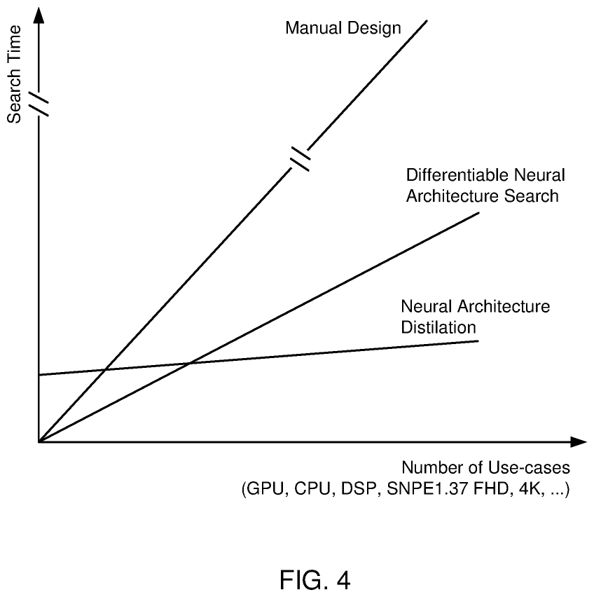

FIG. 4 illustrates a graph of search duration for distilling neural network architectures for any number of use-cases in accordance with various embodiments. The embodiments described herein provide advantages over existing NAS methods. Three approaches to designing a neural network are presented in the graph illustrated in FIG. 4, including manual design, differentiable NAS, and the embodiments described herein (Neural Architecture Distillation). The graph charts search time (e.g., time, processor (e.g., GPU) time or flops, etc.) for developing neural network architecture(s) to a number of use-cases (e.g., neural network applications, hardware configurations, platform software configurations, etc.). As illustrated in the graph, an initial cost of developing neural network architecture(s) for a lower number of use-cases for the manual design and differentiable NAS approaches may be lower than the embodiments described herein. The higher initial search time for the embodiments described herein may be due to blockwise knowledge distillation training various partial neural networks (blocks) used to develop an accuracy model. The graph further illustrates that as the number of use-cases increase, typically requiring development of further neural network architectures, the search time becomes favorable to the embodiments described herein as compared to the manual design and differentiable NAS approaches. The favorable search time for higher uses cases for the embodiments described herein may be due to the ability to use a previously built accuracy model repeatedly for additional use-cases. The applicability of built accuracy models across multiple uses cases reduces the amount of work and resources used for building a neural network architecture for all additional use-cases, whereas the manual design and differentiable NAS approaches must be fully implemented for each additional use-case. Additionally, the embodiments described herein may allow for a neural network architecture for a use-case to be fine-tuned using knowledge distillation and neural network blocks trained by the blockwise knowledge distillation for building the accuracy model. The fine-tuning of neural network architecture for each use-case may be less time and resource consuming than having to fully train a neural network architecture each use-case as with the manual design and differentiable NAS approaches.

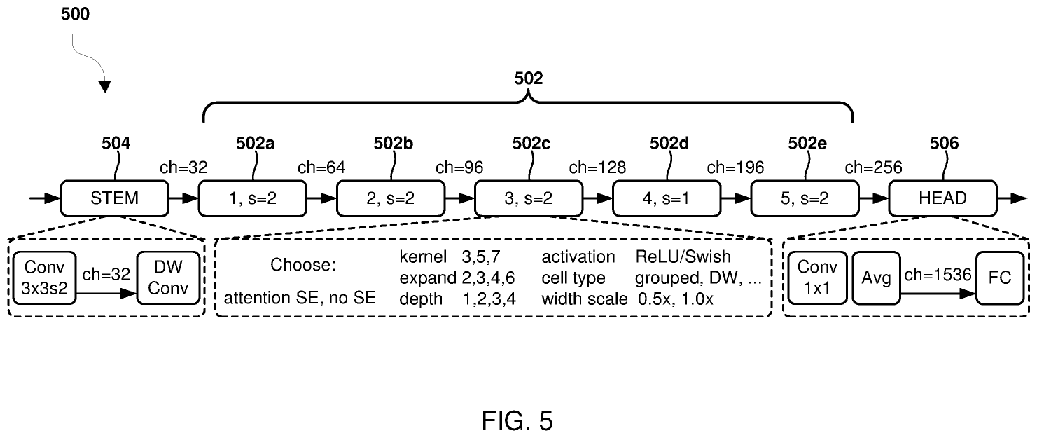

FIG. 5 illustrates an example reference neural network defined in a search-space for distilling neural network architectures in accordance with various embodiments. With reference to FIGS. 1A-5, a search-space may be set to provide every potential neural network architecture as a neural network of N blocks 502 (e.g., block 1 502a, block 2 502b, block 3 502c, block 4 502d, block 5 502e), which may be referred to herein as search blocks, where N is a positive integer. Every block 502 B_n may be any of X_n block implementations, with varying cell type (“cell type”) (e.g., style of convolutions), attention mechanisms (“attention”), kernel sizes (“kernel”), number of layers per block, activation functions (“activation”), expansion rates (“expand”), network width (“width scale”), network depth (“depth”), output channels (“ch”), etc. In an example, the choices for implementing a block 502 B_n (e.g., block 3 502c) may include cell types of grouped, depthwise (“DW”), etc.; attention mechanisms self-attention (“SE”), no SE etc.; kernel sizes of 3, 5, 7, etc.; activation functions of ReLU/Swish, etc.; expansion rates of 2, 3, 4, 6, etc.; network widths of 0.5×, 1.0×, etc.; network depths of 1, 2, 3, 4, etc. The blocks 502 B_n may include output channels ch=64, ch-96, ch=128, ch=196, ch=256, etc. The total number of architectures in this space may be computed as X^{N}, where size of X_n=X for every block 502 B_n. The implementation of block 502 n (e.g., block 5 502e) may be denoted as B_xn. For example, a reference neural network 500 of N blocks 502 may be defined for the search-space to define the number of neural network blocks for each neural network architecture in the search space. As such, structural restrictions on the network architectures may be limited, such as being limited to spatial dimensions of the tensors input and output from the blocks matching those of the reference model. In some embodiments, the search space of included constraints embodied by the reference neural network 500 of a fixed stem 504 (“STEM”) and head 506 (“HEAD”) and N variable blocks, each with a fixed stride(s) (e.g., s=1, s=2). The fixed stem 504 and head 506 may be neural networks of various blocks and/or layers of various configurations, such as a stem 504 having a convolutional (“Cony”) blocks configured as Cony 3×3s2 with ch=32 and DW Cony and a head 506 having Cony 1×1 and an averaging (“Avg”) block with ch=1536 and a fully connected (“FC”) layer. In some embodiments, the dimensions of the search space and blocks within the search space may be noted in terms of N blocks 502 and X parameter options, where X is any positive integer.

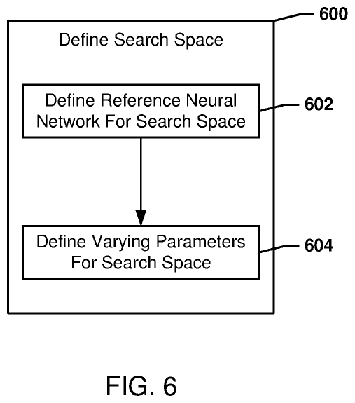

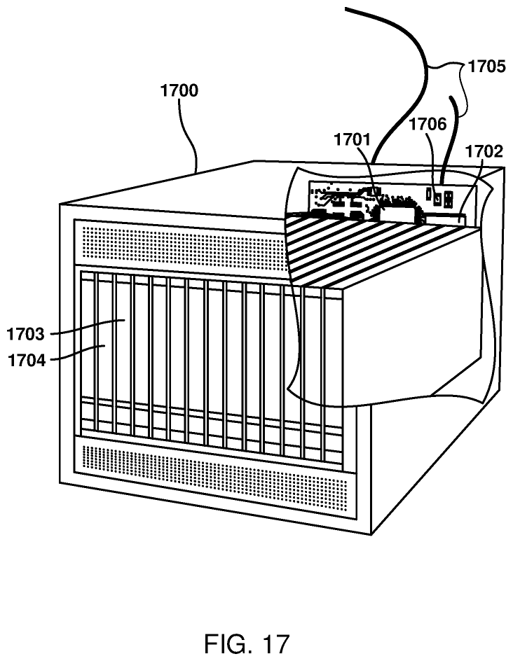

FIG. 6 illustrates a method of defining a search-space for distilling neural network architectures in accordance with various embodiments. With reference to FIGS. 1A-6, method 600 may be performed by a processor in a computing system that implements all or portions of a neural network. Means for performing functions of each of the operations in the method 600 include a processor, such as processor 1701 (FIG. 17). In some embodiments, the method 600 may be implemented as few as one time for building multiple neural network architectures for various use-cases.

In block 602, the processor may define a reference neural network for a search-space. The reference neural network, as describe herein with reference to FIG. 5, the reference neural network may be used to define constraints of the neural network architectures included in the search-space. For example, the reference neural network may define N number of variable blocks. For another example, the reference neural network may define a fixed stem and head and N variable blocks, each with a fixed stride. In some embodiments, the processor may receive parameters for defining the reference neural network from a user input or from a memory accessible to the processor.

In block 604, the processor may define varying parameters for the search space. The varying parameters may be used to define the neural network architectures included in the search-space. The varying parameters may include varying cell-type (e.g., style of convolutions), attention mechanisms, kernel sizes, number of layers per block, activation functions, expansion rates, network width, network depth, etc. Any number and combination of the varying parameters and the constraints of the reference neural network may define a block or neural network architecture in the search space. In some embodiments, the processor may receive varying parameters from a user input or from a memory accessible to the processor.

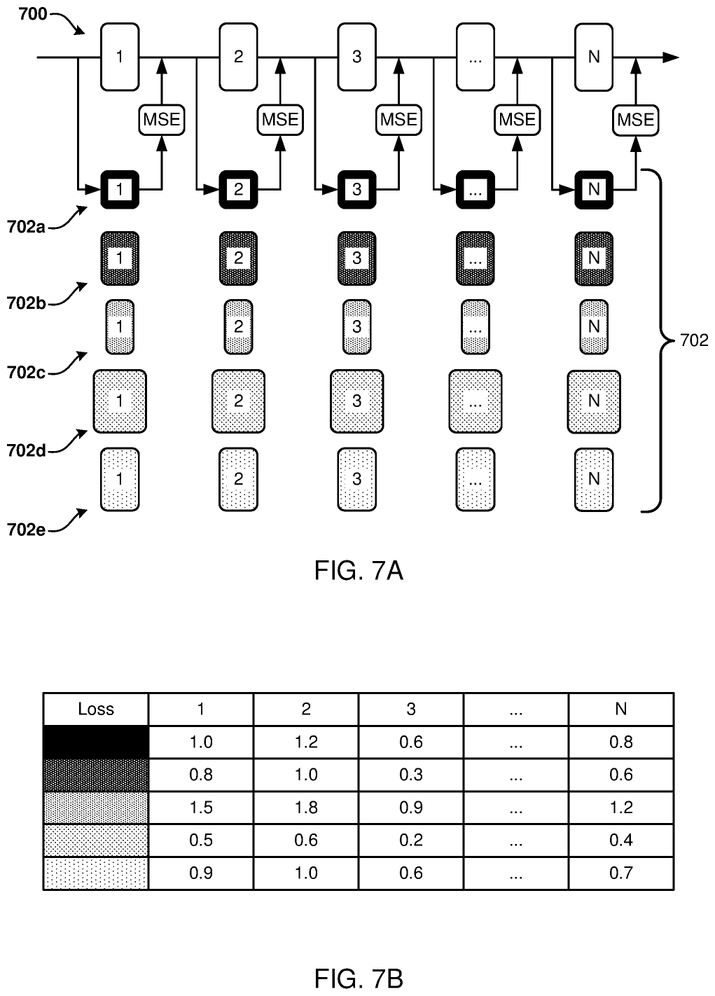

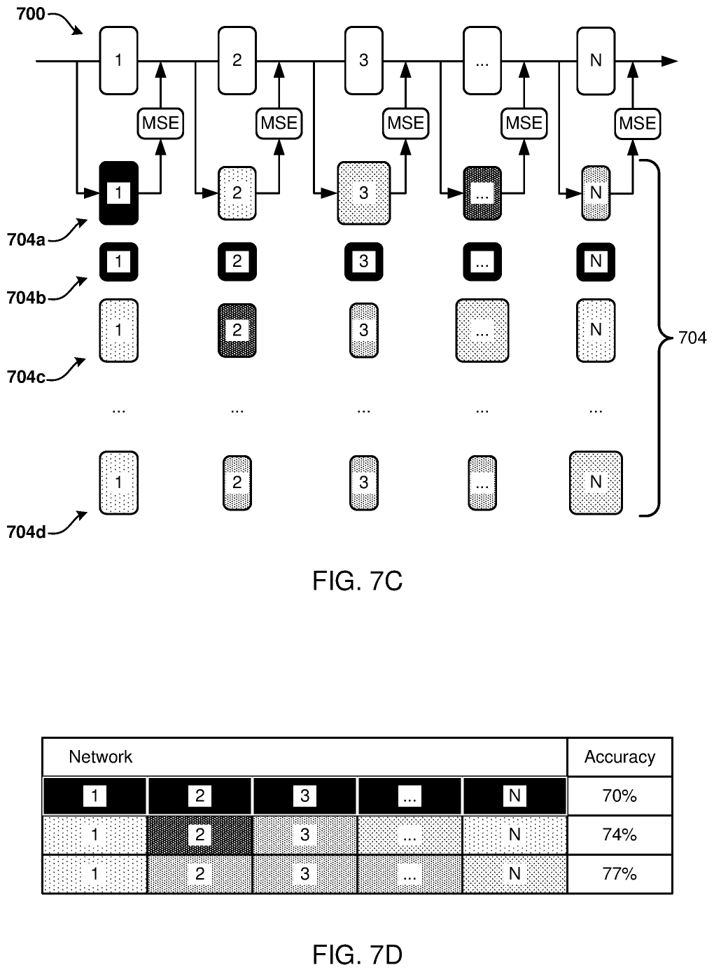

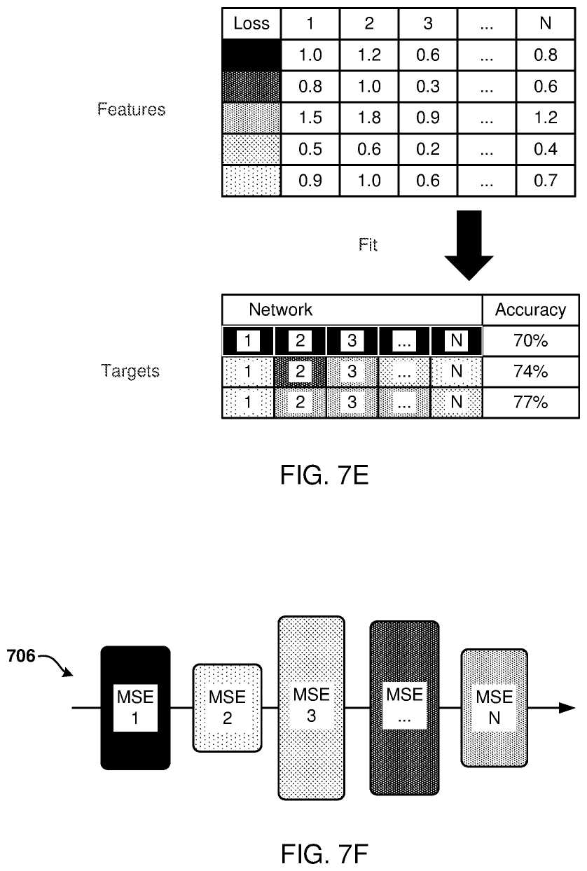

FIGS. 7A-7F illustrate structures and functions for generating an accuracy model using blockwise knowledge distillation for distilling neural network architectures in accordance with various embodiments. For a search space, as described herein with reference to FIG. 5, an accuracy model may be built using blockwise knowledge distillation, which may be able to predict a neural network's accuracy without having to train and validate it.

With reference to FIGS. 1-7F, a trained reference neural network 700 (e.g., non-shaded blocks 1, 2, 3, . . . , N) may be used to implement blockwise knowledge distillation to any number and combination of blocks (e.g., shaded blocks 1, 2, 3, . . . , N, for which shading, size, and labeling may indicated same of different characteristics between blocks) defined in the search space, an example of which is illustrated in FIG. 7A. The individual blocks of the trained reference neural network 700 may be used to train individual blocks of the neural network architectures 702 (e.g., rows of shaded blocks 702a, 702b, 702c, 702d, 702e, such as like-sized and shaded blocks) defined in the search space (e.g., using non-shaded blocks 1, 2, 3, . . . , N to train like-labeled shaded blocks 1, 2, 3, . . . , N). The individual blocks of the neural network architectures 702 may be trained such that a loss function, such as mean square error (MSE), per-channel Noise-To-Signal ratio (NSR), or any other relevant loss function, between the outputs of the blocks of the trained reference neural network 700 and the individual blocks of the neural network architectures 702 is reduced, such as to within a loss function threshold. For example, the loss function defined between the blocks of the trained reference neural network 700 and the individual blocks of the neural network architectures 702 may converge to within the loss function threshold while training the individual blocks of the neural network architectures 702.

To implement the blockwise knowledge distillation a reference neural network 700 may be selected, trained, and split it into N blocks BT_n. This block BT_n may transform input feature map DT_(n-1) into DT_n using a transfer function FT_n(WT_n), where WT_n are the parameters of the block.

Using the trained reference neural network 700, the parameters of all possible blocks B_xn in the search space may be trained. This may allow for (A) extracting quality metrics useful in building supervised regression models for accuracy and (B) initializing their weights for building unsupervised accuracy models, or for quick fine-tuning of models in the search space.

In some embodiments, training the parameters of all possible blocks B_xn in the search space may be implemented using blockwise knowledge distillation. The parameters W_xn of all the blocks B_xn, which define the transfer function F_xn(W_xn), may be trained using a blockwise knowledge distillation scheme to approximate the reference function F_n as closely as possible. This is done in a block-wise way by using stochastic gradient descent, requiring gradient back-propagation only from DT_n to DT_(n−1) through B_xn. This process may reduce MSE, per-channel Noise-To-Signal ratio (NSR), or any other relevant loss function of the output features D_xn relative to the trained reference neural network 700 DT_n, using the trained reference neural networks' DT_(n−1) input feature maps. In some embodiments. This blockwise knowledge distillation may converge the loss function quickly, such as after 1 full epoch of training.

In some embodiments, training the parameters of all possible blocks B_xn in the search space may be implemented using conventional knowledge distillation: In some embodiments, the weights W_xn of B_xn may be updated using conventional knowledge distillation, by minimizing a loss function defined by the tasks ground truth and the output classifier of the trained reference neural network 700. In such embodiments, a new neural network may be constructed where as few as 1 out of the N blocks of the trained reference neural network 700 is replaced by block B_xn. The new neural network is then used to train the weights W_xn of B_xn through knowledge distillation.

A knowledge distillation, blockwise or conventional, trained neural network 700 is described as M_xn. In some embodiments other methods may be used to train the blocks of the search space.

The knowledge distillation, blockwise or conventional, may be used as a means to measure the quality of a block B_n,x in the search space and to initialize its weights for later fine-tuning. The knowledge distillation process may result in a block library of quality metrics, an example of which is illustrated in FIG. 7B (e.g., in which shading and labels may correspond to like shaded and labeled blocks in FIG. 7A), as well as the pretrained weights W_n,x for every block B_n,x. In some embodiments, the total number of blocks B_n,x may grow linearly as N×X, whereas the overall search space may grow exponentially as M\hat{ }X. In some embodiments, the NSR may be used as a metric indicating the quality of the block B_n,x. In some embodiments, the MSE may be used as a metric indicating the quality of the block B_n,x. The quality metrics computed over the linearly-growing library may be used to build an accuracy model, or accuracy predictor, for the exponentially-growing search space. Later, the block weights Wn,x from blockwise knowledge distillation may serve as the weight-initialization for quickly fine-tuning any neural network architecture sampled from the search-space, such as to full accuracy.

A dataset of fully trained neural networks may be built for the search space. The built accuracy predictor may be trained using parameters including features (e.g., quality metrics) and targets (e.g., accuracy), an example of which is illustrated in FIG. 7D (e.g., in which shading and labels may correspond to like shaded and labeled blocks in FIG. 7C). The target parameters may be developed by fine-tuning a number of sampled neural networks 704 (e.g., rows of shaded blocks 704a, 704b, 704c, 704d, such as variably shaded and/or sized blocks) from the search space, an example of which is illustrated in FIG. 7C (e.g., in which blocks having shading, sizing, and labels may correspond to like shaded, sized, and labeled blocks in FIG. 7A). Fine-tuning may involve training the sampled neural networks 704 using their initializations yielded from the blockwise knowledge distillation using end-to-end knowledge distillation. Using the initializations yielded from the blockwise knowledge distillation may reduce the resources needed to fine-tune the sampled neural networks 704 compared to training from scratch to match from scratch training accuracy. In some embodiments, fine-tuning up to full accuracy may be accomplished in 15-50 epochs depending on the complexity and variety of the search space. In some embodiments, fine-tuning may be 9-30 times faster compared to training from scratch to match from scratch training accuracy. In some embodiments, the neural networks may be trained from scratch. These fine-tuned neural networks 704 may also be referred to herein as distilled neural networks.

These fine-tuned neural networks 704 may then be used to build an accuracy predictor 706, an example of which is illustrated in FIG. 7F such as in which blocks having shading, sizing, and labels may correspond to like shaded, sized, and labeled blocks in FIG. 7C, and may indicate the loss function, such as MSE, for which the blocks have been trained to reduce. A number of blockwise features (e.g., features illustrated in FIG. 7B) may be used to build a ranking of architectures in the search space (e.g., targets illustrated in FIG. 7D), an example of which is illustrated in FIG. 7E. After fine-tuning the blocks B_xn, accuracy features may be derived from the blocks in a multitude of ways. In some embodiments, these features may be used to rank neural network architectures 704 in the search space. In some embodiments, these features may be used to build a supervised accuracy model.

In some embodiments, the NSR of the feature maps may be between a trained reference neural network 700 and fine-tuned neural network 704. This may be understood as a measure of the distance between F_n and F_xn. The closer F_xn is to F_n, the higher the quality of block B_xn and the lower the average NSR or MSE. Herein, these features may be referred to as B_xna, as there are many different types of metrics that can be used here. In some embodiments, Signal-To-Noise ratio (SNR) may be used in the same way. In some embodiments, NSR may be used in the same way. In some embodiments, MSE may be used in the same way.

In some embodiments, training/validation loss of a fine-tuned neural network 704 M_xn may be used as an accuracy target to fit the accuracy predictor 706. In some embodiments, the accuracy of the fine-tuned neural network 704 may be determined on a validation set. In some embodiments, the accuracy of the fine-tuned neural network 704 may be determined on a part of a fine-tuning set.

In some embodiments, direct validation, by validating samples of the search space M_n, with all blocks B_xn being fine-tuned may be used. After batch-norm statistics are reset for the network M_n, the resulting network may be validated. This validation accuracy may be used to model the accuracy of when the network M_n should be trained from scratch.

In some embodiments, other available measures may be used as targets to build an accuracy predictor 706.

In some embodiments, using a dataset of fully trained neural networks (e.g., fine-tuned neural networks 704, up to full accuracy) in the search space, a supervised accuracy model may be built using features (e.g., quality) and targets (e.g., accuracy) via various different means. In some embodiments, the accuracy model may be built using a linear regression model. In some embodiments, the accuracy model may be built using a gradient boosting regression model. In some embodiments, the accuracy model may be built using a multilayer perceptron models. In some embodiments, the accuracy model may be built using a graph convolutional neural network combining accuracy features and graph features.

The means to build an accuracy model described herein, poses no limitations on the variety of the search space, as opposed to existing NAS methods, which either rely on weight sharing or have a limited search space due to GPU-memory limitations. These limitations of existing NAS methods severely limit their variety as not all cell-types or activation and attention styles can share weights. In existing NAS methods, because of their reliance on weight sharing, all blocks B_xn would have to belong to the same cell-type (depth wise separable convolutions for example) with the same activation functions and attention mechanisms. The means described herein, has may not be similarly limited, and may allow for mixing different cell-types, activation functions, quantization levels and/or attention mechanisms, while still being able to model their accuracy reliably. In some embodiments, means to build an accuracy model described herein may allow for building an accuracy model for a single search space with different attention mechanisms, activation functions, cell-types, channels, quantization settings. In some embodiments, means to build an accuracy model described herein may allow for adding quantized blocks into the search space, which may build an accuracy model for quantized networks directly. In some embodiments, the accuracy predictor 706 may be understood as a coarse sensitivity model that may indicate which blocks require complex implementations in order to build neural networks with high accuracy.

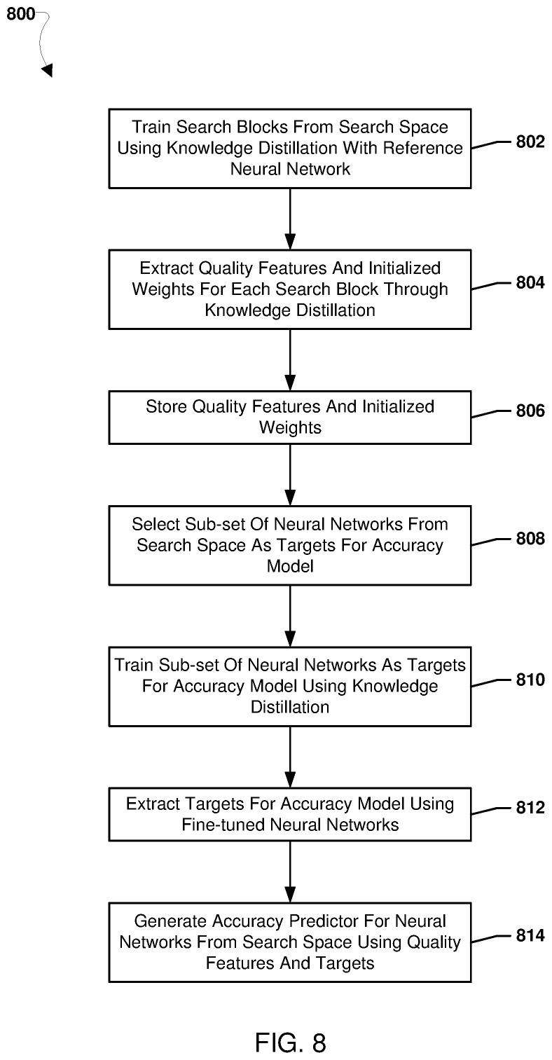

FIG. 8 is a method of generating an accuracy model using blockwise knowledge distillation for distilling neural network architectures in accordance with various embodiments. With reference to FIGS. 1A-8, method 800 may be performed by a processor in a computing system that implements all or portions of a neural network. Means for performing functions of each of the operations in the method 800 include a processor, such as processor 1701 (FIG. 17). In some embodiments, the method 800 may be implemented as few as one time for building multiple neural network architectures for various use-cases.

In block 802, the processor may train any number and combination of search blocks from the search space using knowledge distillation with a trained reference neural network, as describe herein with reference to FIG. 7A. In some embodiments, the search blocks trained using knowledge distillation may be blocks making up a neural network architecture from the search space, as describe herein with reference to FIG. 5. In some embodiments, the processor may train all of the search blocks from the search space using knowledge distillation with the trained reference neural network. In some embodiments, the search blocks may be trained using blockwise knowledge distillation in which the search blocks are associated with blocks of the trained reference neural network and trained using the associated blocks to converge a loss function of each search block with a loss function of an associated block. In some embodiments, the search blocks may be trained using conventional knowledge distillation in which a neural network architecture having search blocks may be trained using the trained reference neural network to converge a loss function of the neural network architecture with a loss function of the trained reference neural network. For examples, the loss function of the blocks and/or the neural networks may converge while training the search blocks to an accuracy level, up to full accuracy. For example, convergence of the loss function of the blocks and/or the neural networks may be to within a loss function threshold.

In block 804, the processor may extract quality features and initialize weights for each search block through knowledge distillation, as described herein with reference to FIG. 7B. In some embodiments, the processor may use various means to determine the quality of the feature maps produced by the trained search block and/or neural network architecture. In some embodiments, extracting a quality feature may include determining an NSR of the feature maps between a trained reference block and/or neural network and a trained search block and/or neural network architecture. In some embodiments, training the search block and/or neural network architecture may initialize weights of the trained search block and/or neural network architecture that may be used for later implementation of the trained search block and/or neural network architecture.

In block 806, the processor may store the quality features and initialize weights for each trained search block and/or neural network architecture. The processor may store the quality features and initialize weights in a manner that associates the quality features and initialize weights with respective trained search blocks and/or neural network architectures. The processor may store the quality features and initialize weights using any manner of storage, such as a database, a list, a table, an array, etc. The processor may store the quality features and initialize weights to any memory (e.g., memory 1702, disk drive 1703 in FIG. 17).

In block 808, the processor may select a sub-set of neural networks from the search space as targets for building an accuracy model. In some embodiments, the processor may select the sub-set of neural networks from the search space based on a programmed algorithm, heuristic, technique, criteria, etc. In some embodiments, the processor may select the sub-set of neural networks from the search space based on a user input. In some embodiments, each of neural networks of the sub-set may include any combination of trained search blocks. In some embodiments, the neural networks of the sub-set may include any combination of trained neural networks of the search space.

In block 810, the processor may train fine-tune the sub-set of neural networks as targets for building an accuracy model using knowledge distillation, as described herein with reference to FIG. 7C. In some embodiments, the processor may train the sub-set of neural networks from scratch. In some embodiments, the processor may train the sub-set of neural networks by fine-tuning the sub-set of neural networks. In some embodiments, the processor may further train the search blocks of the sub-set of neural networks using blockwise knowledge distillation as described herein in block 802. In some embodiments, the processor may further train the neural networks of the sub-set of neural networks using conventional knowledge distillation as described herein in block 802. The processor may fine-tune the sub-set of neural networks using the initialized weights associated with each search block and/or neural networks stored in block 806. The processor may fine-tune the sub-set of neural networks using the initialized weights rather than training the sub-set of neural networks from scratch.

In block 812, the processor may extract targets for building an accuracy model using the fine-tuned neural networks, as described herein with reference to FIG. 7D. In some embodiments, the targets may be accuracy measurements of the fine-tuned neural networks. In some embodiments, accuracy may be measured using the NSR of the feature maps between a trained reference neural network and fine-tuned neural network where the lower the average NSR of the blocks the higher the accuracy. In some embodiments, accuracy may be measured using SNR of the feature maps between a trained reference neural network and fine-tuned neural network where the lower the average SNR of the blocks the higher the accuracy. In some embodiments, accuracy may be measured using fine-tuning/validation accuracy of a fine-tuned neural network. In some embodiments, the accuracy of the fine-tuned neural network may be determined on a validation set. In some embodiments, the accuracy of the fine-tuned neural network may be determined on a part of a fine-tuning set. In some embodiments, accuracy may be measured using training/validation loss of a fine-tuned neural network. In some embodiments, the accuracy of the fine-tuned neural network may be determined on a validation set. In some embodiments, the accuracy of the fine-tuned neural network may be determined on a part of a fine-tuning set. In some embodiments, accuracy may be measured using direct validation, by validating samples of the search space, with all search blocks being fine-tuned. After batch-norm statistics are reset for the fine-tuned neural network, the resulting network may be validated. This validation accuracy may be used to model the accuracy of when a neural network should be trained from scratch.

In block 814, the processor may generate an accuracy predictor for neural networks from the search space using the quality features and targets, as described herein with reference to FIG. 7E. In some embodiments, using a dataset of fully trained neural networks (e.g., fine-tuned neural networks, up to full accuracy) in the search space, a supervised accuracy model may be built using the features (e.g., quality) and targets (e.g., accuracy) via various different means. In some embodiments, the accuracy model may be built using a linear regression model. In some embodiments, the accuracy model may be built using a gradient boosting regression model. In some embodiments, the accuracy model may be built using a multilayer perceptron model. In some embodiments, the accuracy model may be built using a graph convolutional neural network combining accuracy features and graph features. The accuracy predictor may be used for any neural network in the search space. The accuracy predictor may be used for any neural network outside of the search space, if the same quality metrics are extracted for that external search space, as the ones used to fit the original predictor.

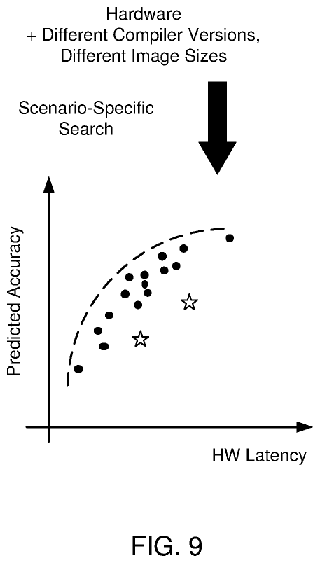

FIG. 9 illustrates searching for a neural network architecture from a search-space for distilling neural network architectures in accordance with various embodiments. With reference to FIGS. 1A-9, given the accuracy model and the collection of fine-tuned blocks, a search algorithm may be implemented to identify search blocks and/or neural networks in the search space that achieve a particular balance between predicted accuracy and a cost for execution of the fine-tuned blocks and/or neural networks. In some embodiments, the search algorithm may be a Y-dimensional search algorithm, where Y is any integer greater than 1, executed to find blocks and/or neural networks in the search space that achieve a certain model accuracy, up to maximum model accuracy, and any number and combination of certain target cost functions, such as a minimum target cost function. In some embodiments, the search algorithm may be an evolutionary algorithm executed to find Pareto-optimal search blocks and/or neural networks in the search space that achieve a certain model accuracy, up to maximum model accuracy, and a certain a target cost function, such as a minimum target cost function. In some embodiments, the cost function may be scenario-agnostic. In some embodiments, the cost function may be scenario-aware. The scenarios may include hardware configurations, software versions, input data parameters, a number of operations or a number of parameters in a neural network, on-device latency, throughput, energy, etc.

For example, as illustrated in FIG. 9, a two-dimensional criterion may be used for the search, in which predicted accuracy is balanced with hardware latency. The blocks of the search space, represented here by points, may be plotted based on the predicted accuracy for each block using the accuracy predictor and based on measured and/or predicted hardware latency for implementing the blocks. The dashed line may represent a frontier at which the search may identify as values for which blocks would best suit the criteria. The points plotted closest to the line may represent blocks which the search may identify as best suit the criteria. The stars may represent blocks identified using existing NAS methods.

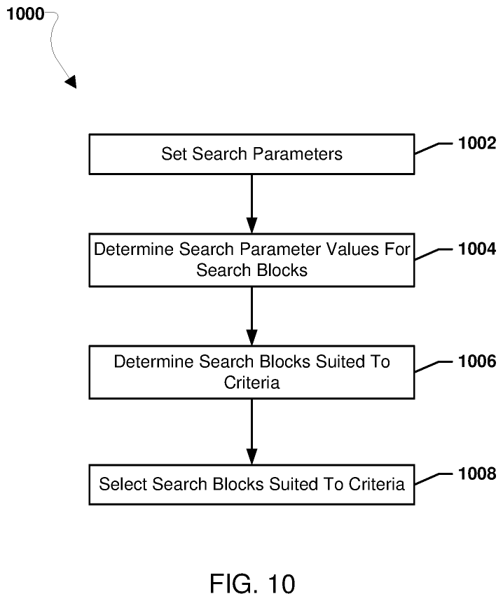

FIG. 10 is a process flow diagram illustrating a method of searching for a neural network architecture from a search-space for distilling neural network architectures in accordance with various embodiments. With reference to FIGS. 1A-10, method 1000 may be performed by a processor in a computing system that implements all or portions of a neural network. Means for performing functions of each of the operations in the method 1000 include a processor, such as processor 1701 (FIG. 17).

In block 1002, the processor may set search parameters. In some embodiments, search may parameters may include a predicted accuracy and a cost function for executing search blocks, as described herein with reference to FIG. 5. The predicted accuracy may be the results of applying the accuracy predictor, as described herein with reference to FIG. 7F, to the search blocks. In some embodiments, the cost function may be scenario-agnostic, such to as a number of operations or a number of parameters in a neural network. In some embodiments, the accuracy predictor may be configured to account for scenario specific parameters for the search. In some embodiments, the cost function may be scenario-aware. The scenarios may include hardware configurations, software versions, input data parameters, a number of operations or a number of parameters in a neural network, on-device latency, throughput, energy, etc. In some embodiments, the processor may set the search parameters based on programmed parameters retrieved from a memory (e.g., memory 1702, disk drive 1703 in FIG. 17) accessible to the memory. In some embodiments, the processor may set the search parameters based on a user input.

In block 1004, the processor may determine search parameter values for search blocks. In some the processor may apply the accuracy predictor to the search blocks to determine the predicted accuracy values for the search blocks. In some embodiments, the processor may calculate cost function values for implementing the search blocks. In some embodiments, the processor may measure cost function values for implementing the search blocks. In some embodiments, the processor may retrieve cost function values for implementing the search blocks from the memory accessible to the processor. In some embodiments, the processor may receive cost function values for implementing the search blocks via user input. In some embodiments, the cost function may be scenario-agnostic. In some embodiments, the cost function may be scenario-aware. The scenarios may include hardware configurations, software versions, input data parameters, a number of operations or a number of parameters in a neural network, on-device latency, throughput, energy, etc.

In block 1006, the processor may determine search blocks suited to the criteria. The processor may execute a search algorithm. In some embodiments, the search algorithm may be an evolutionary search algorithm, described herein with reference to FIG. 9. The search algorithm may be configured to identify any number and combination of search blocks, such as N search blocks, suited to the criteria. The configuration of the search algorithm may control whether search parameter values for search blocks may be interpreted as suited to the criteria. In some embodiments, the search algorithm may be a Y-dimensional search algorithm, where Y is any integer greater than 1, executed to find search blocks that achieve a certain model accuracy, up to maximum model accuracy, and any number and combination of certain target cost functions, such as a minimum target cost function. For example, the search criteria may be a two-dimensional search criteria balancing predicted accuracy and cost for implementing search blocks. The search criteria may be to identify Pareto-optimal search blocks for inclusion in a neural network.

In block 1008, the processor may select the search blocks suited to the criteria. In some embodiments, the processor may select any number and combination of search blocks suited to the criteria, such as N search blocks suited to the criteria. In some embodiments, the processor may select the search blocks best suited to the criteria. In some embodiments, the processor may select search blocks suited to the criteria within selection parameters. In some embodiment the selection parameters may include a function of the cost function for any number and combination of the search blocks suited to the criteria. In some embodiment the selection parameters may include a function of the predicted accuracy for any number and combination of the search blocks suited to the criteria.

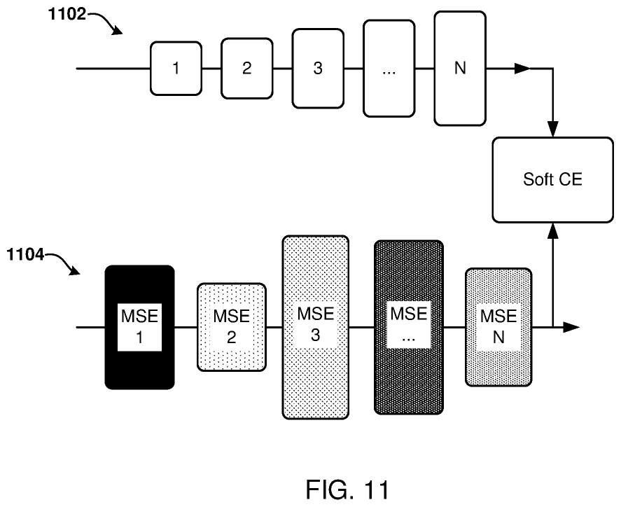

FIG. 11 illustrates fine-tuning a neural network architecture from a search-space for distilling neural network architectures in accordance with various embodiments. With reference to FIGS. 1A-10, any neural network 1102 from the search space (e.g., non-shaded blocks 1, 2, 3, . . . , N in neural networks 702 in FIG. 7A) may be fine-tuned using a trained neural network 1104 having blocks trained using knowledge distillation such as shaded blocks 1, 2, 3, . . . , N, for which blocks having shading, sizing, and labels may correspond to like shaded, sized, and labeled blocks in FIG. 7F, neural networks 704 in FIG. 7C, or accuracy predictor 706 in FIG. 7F. The neural network 1102 from the search space may include any number and combination of search blocks, as described herein with reference to FIG. 5. The neural network 1102 may include any number and combination of trained blocks, as described herein with reference to FIG. 7A. The neural network 1102 from the search space may be quickly fine-tuned to match the from-scratch training accuracy by initializing the neural network 1102 with weights from the knowledge distillation process for the search blocks of the neural network 1102. Fine-tuning may be further sped up by using end-to-end knowledge distillation using the trained reference neural network 1104, as described herein with reference to FIG. 7A. The neural network 1102 from the search space and initialized with weights from the knowledge distillation of the search blocks may be fine-tuned using by using end-to-end knowledge distillation using the trained reference neural network 1104. The neural network 1102 from the search space may be fine-tuned for an accuracy level, up to full accuracy. Fine-tuning the neural network 1102 from the search space may be completed to the same accuracy as training the neural network from scratch in 15-50 epochs depending on the complexity and variety of the search space, which may be 9-30 times faster.

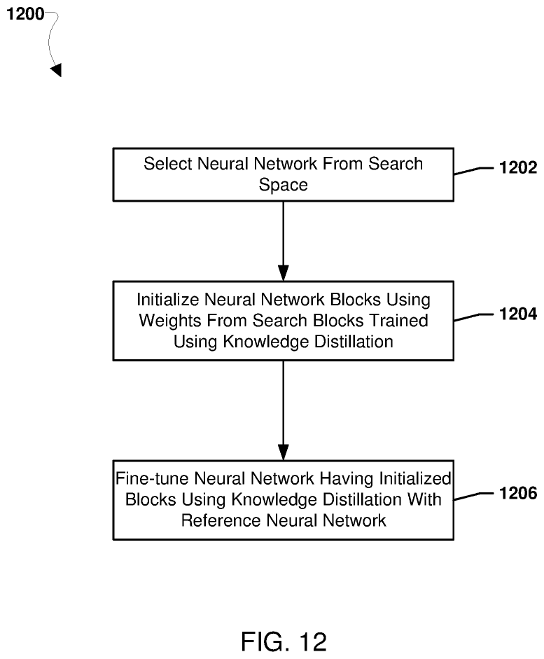

FIG. 12 illustrates a method for fine-tuning a neural network architecture from a search-space for distilling neural network architectures in accordance with various embodiments. With reference to FIGS. 1A-12, method 1200 may be performed by a processor in a computing system that implements all or portions of a neural network. Means for performing functions of each of the operations in the method 1200 include a processor, such as processor 1701 (FIG. 17).

In block 1202, the processor may select a neural network from the search space, as described herein with reference to FIG. 5. The neural network from the search space may include any number and combination of search blocks. In some embodiments, the processor may select the neural network based on the selection of search blocks suited to the criteria, described herein for block 1008 of the method 1008 with reference to FIG. 10.

In block 1204, the processor may initialize the neural network from the search space using weights from the training of the search blocks using knowledge distillation, as described herein with reference to FIG. 11. The processor may retrieve the weights for the trained search blocks of the neural network from a memory (e.g., memory 1702, disk drive 1703 in FIG. 17) to which the weights were stored, as described herein for block 806 of the method 800 with reference to FIG. 8. The processor may load the weights for use with the respective search blocks in fine-tuning the neural network.

In block 1206, the processor may fine-tune the neural network having search blocks initialized with the weight from the knowledge distillation by using knowledge distillation with a trained reference neural network, as described herein with reference to FIG. 11. The neural network may be fine-tuned starting with the initialized search blocks rather than training the neural network from scratch. The neural network may be fine-tuned by further using knowledge distillation with the trained reference neural network. In some embodiments, the neural network from the search space may be fine-tuned for an accuracy level, up to full accuracy.

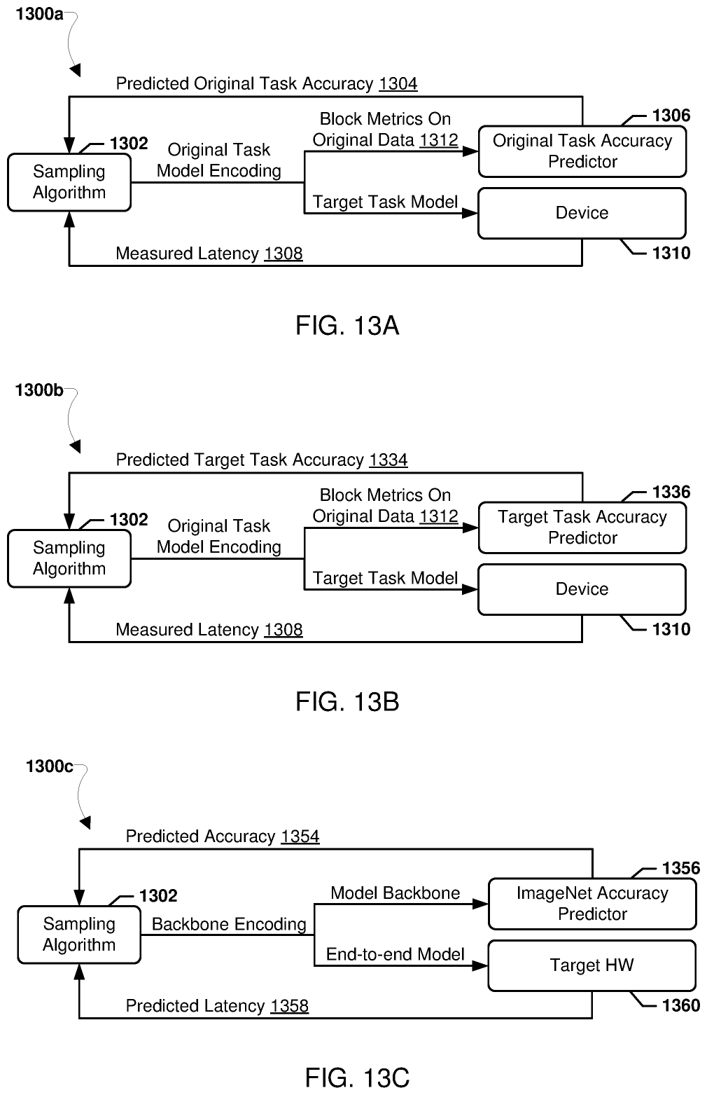

FIGS. 13A-15 illustrate a method for applying a distilled neural network architecture from a search-space to a downstream task in accordance with various embodiments. With reference to FIGS. 1A-14, methods 1300a, 1300b, 1300c, 1400 may be performed by a processor in a computing system that implements all or portions of a neural network. Means for performing functions of each of the operations in the methods 1300a, 1300b, 1300c, 1400 include a processor, such as processor 1701 (FIG. 17).

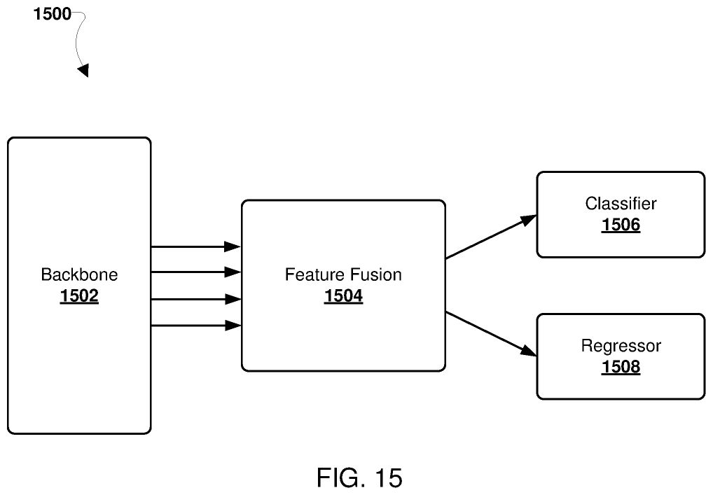

A downstream task may be a task that is not directly performed by a distilled neural network, or a fine-tuned neural network, from the search space, as described herein with reference to FIG. 11, but for which such a distilled neural network may contribute to the implementation of the task. An example of a neural network 1500 having a distilled neural network 1502 (e.g., backbone) feeding (e.g., via a process 1504, such as feature fusion) into a neural network 1506, 1508 (e.g., classifier and/or regressor) for implementing a downstream task is illustrated in FIG. 15. The final result of the task may be generated by another process, such as a different neural network. For example, a distilled neural network may be configured for image recognition and a downstream task may include object detection, semantic image segmentation, video classification, etc.

In FIGS. 13A-13C, the processor may implement a sampling algorithm 1302, which may be implemented for a search for suitable search blocks, such as the search algorithm described herein with reference to FIG. 9 and the method 1000 described herein with reference to FIG. 10. The sampling algorithm may take a predicted accuracy value 1304, 1334, 1354 from the accuracy predictor 1306, 1336, 1356 (e.g., original task accuracy predictor, target task accuracy predictor, ImageNet accuracy predictor), as described herein with reference to FIG. 7F, as a proxy metric for accuracy of the process implementing the downstream task. The sampling algorithm 1302 may use the proxy information to update the search for search blocks to generate a distilled neural network, as described herein with reference to FIG. 11, to be used for a neural network configured to contribute to the downstream task.

The sampling algorithm may also take cost function metric 1308, 1358 (e.g., measured latency, predicted latency). To determine a cost function value, the distilled neural network may be embedded into a larger neural network, which may include parts 1310, 1360 (e.g., device, target hardware (HW)) for implementing the downstream task. The cost function metric may be measured for the larger neural network including the distilled neural network implemented on a hardware or hardware simulator. The sampling algorithm may use the cost function metric to update the search for search blocks to be used for a neural network configured to contribute to the downstream task.

In some embodiments, the search for suitable search blocks may be executed based on a predicted accuracy of a task generated by an accuracy predictor (e.g., accuracy predictor 706 in FIG. 7F) and a measured latency 1308 of sampled search blocks measured at a device 1310. For example, as illustrated in FIG. 13A, the search for suitable search blocks may be executed based on a predicted original task accuracy 1304 generated by an original task accuracy predictor 1306 using block metrics (e.g., quality metrics) on original data 1312. The original task may be a task different from the downstream task and previously used to develop the original task accuracy predictor 1306 and the block metrics on original data 1312. This example reuses a previously created search space, the previously created original task accuracy predictor 1306, and the block metrics on original data 1312 for the original task. Neural network architectures from the search space may be searched using the predicted original task accuracy 1304 resulting from using the block metrics on original data 1312 as parameters for the original task accuracy predictor 1306. Using the previously created search space, the original task accuracy predictor 1306, and the block metrics on original data 1312 avoids the costs of creating a search space and neural network architectures from which to search, block metrics as search parameters, and an accuracy predictor. The sampled neural network architectures from the search space, resulting from the search, may be initialized on the original task and further trained on the downstream task.

As another example, as illustrated in FIG. 13B, the search for suitable search blocks may be executed based on a predicted target task accuracy 1334 generated by a target task accuracy predictor 1336 using the block metrics on original data 1312. The target task may be the downstream task. This example reuses a previously created search space and the block metrics on original data 1312 for an original task, and uses the target task accuracy predictor 1336 generated for the target task. Neural network architectures from the search space may be searched using the predicted target task accuracy 1334 resulting from using the block metrics on original data 1312 as parameters for the target task accuracy predictor 1336. Using the previously created search space and the block metrics original data 1312 avoids the time spent to create a search space from which to search and block metrics as search parameters. Using the target task accuracy predictor 1336 generated for the target task may result in selection of neural network architectures that may correlate with improved performance in implementing the downstream task than neural network architectures selected using the original task accuracy predictor 1306. The sampled neural network architectures from the search space, resulting from the search, may be initialized on the original task and further trained on the downstream task.

FIG. 13C illustrates a non-limiting example of the search for suitable search blocks as described herein with reference to FIG. 13A. In this example, the search for suitable search blocks may be executed based on a predicted original task accuracy (predicted accuracy 1354) generated by an original task accuracy predictor (ImageNet accuracy predictor 1356) using block metrics on original data (model backbone 1352). The sampling algorithm may use the predicted accuracy 1354 and a predicted latency 1358 of using sampled neural network algorithms on target hardware 1360 for implementing the downstream task to search for suitable search blocks. In the example illustrated in FIG. 13C, the original task may be image classification on the ImageNet dataset and a downstream task may be object detection on the common objects in context (COCO) dataset.

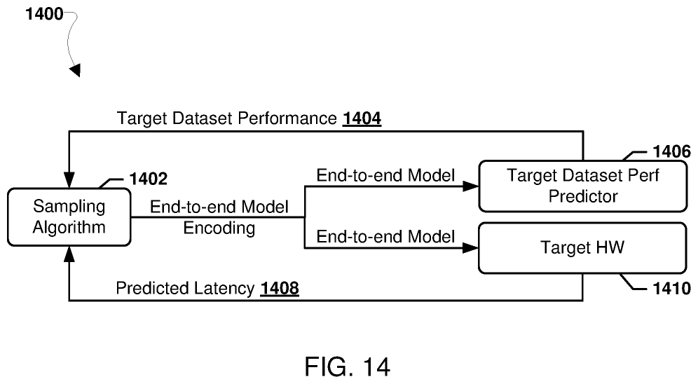

In FIG. 14, the processor may implement a sampling algorithm 1402, which may be implemented for a building a target performance (e.g., accuracy) predictor 1406, as described herein with reference to FIGS. 7A-7F, for the downstream task. The sampling algorithm 1402 may also be implemented for a search for suitable search blocks, such as the search algorithm described herein with reference to FIG. 9 and the method 1000 described herein with reference to FIG. 10. The sampling algorithm may take a target performance value 1404 (e.g., Target Dataset Performance, which may include accuracy) from the target performance predictor 1406 and output end-to-end model encoding. The sampling algorithm may use the target performance information to update the search for search blocks to update the search for search blocks to generate a distilled neural network, as described herein with reference to FIG. 11, to be used for a neural network configured to contribute to the downstream task.

The sampling algorithm may also take cost function metric 1408 (e.g., predicted latency). To determine a cost function value, the distilled neural network may be embedded into a larger neural network, which may include parts 1410 (e.g., Target HW) for implementing the downstream task. The cost function metric may be measured for the larger neural network including the distilled neural network implemented on a hardware or hardware simulator. The sampling algorithm may use the cost function metric to update the search for search blocks to be used for a neural network configured to contribute to the downstream task.

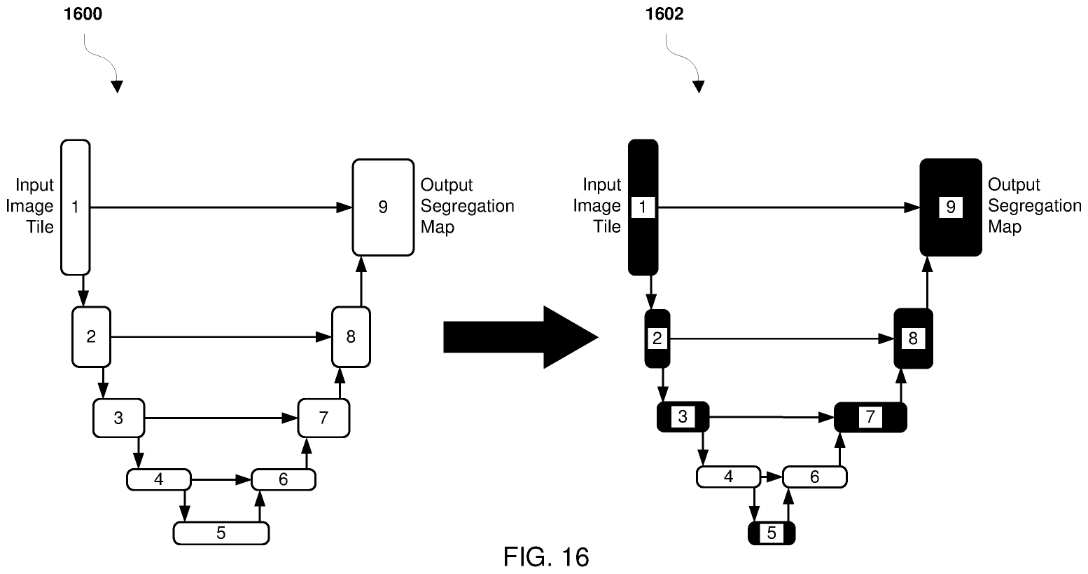

FIG. 16 illustrated applying a distilled neural network architecture from a search-space for refining and compressing a trained neural network in accordance with various embodiments. With reference to FIGS. 1A-16, a trained neural network 1600 may be modified to used trained search blocks (e.g., shaded blocks 1, 2, 3, 4, 7, 8, 9 in neural network 1602) from the search space, as described herein with reference to FIG. 7A, to refine and compress the trained neural network 1600. Refining the trained neural network may retain whole the structure of the trained neural network, replacing the blocks (e.g., non-shaded blocks 1, 2, 3, 4, 7, 8, 9 in neural network 1600) within the trained neural network with trained blocks (e.g., shaded blocks 1, 2, 3, 4, 7, 8, 9 in neural network 1602) from the search space, which may be more efficient on hardware. To accomplish this, the trained neural network 1600 may be used as the reference neural network in the search space, as described herein with reference to FIG. 5, and as the reference neural network for training the search blocks with knowledge distillation, as described herein with reference to FIG. 7A. In some embodiments, refining the neural network 1600 may involve designing a distilled neural network 1602 as a scenario specific version of the neural network. The parameters for the search blocks in the search space and/or the search for search blocks to generate a distilled neural network 1602, as described herein with reference to FIG. 9, may be configured for a specific scenario, such as use-case, hardware configuration, software configuration, etc. As such, distilling a neural network 1600 based on the reference neural network may result in a scenario specific version of the reference neural network, which may be a distilled neural network 1602 configured to perform better for the scenario. In some embodiments, refining the neural network 1600 may involve designing a distilled neural network 1602 as a compressed version of the neural network 1600. The parameters for the search blocks in the search space may be set to be smaller than the corresponding blocks in the reference neural network. As such, distilling a neural network 1600 based on the reference neural network may result in a compressed version of the reference neural network 1600, which may be a smaller and more efficient distilled neural network 1602.

Various embodiments may be implemented on any of a variety of commercially available computing systems and computing devices, such as a server 1700 an example of which is illustrated in FIG. 17. With reference to FIGS. 1A-17, such a server 1700 typically includes a processor 1701 coupled to volatile memory 1702 and a large capacity nonvolatile memory, such as a disk drive 1703. The server 1700 may also include a floppy disc drive, compact disc (CD) or DVD disc drive 1704 coupled to the processor 1701. The server 1700 may also include network access ports 1706 coupled to the processor 1701 for establishing data connections with a network 1705, such as a local area network coupled to other operator network computers and servers.

The processor 1701 may be any programmable microprocessor, microcomputer or multiple processor chip or chips that may be configured by software instructions (applications) to perform a variety of functions, including the functions of the various embodiments described in this application. In some wireless devices, multiple processors may be provided, such as one processor dedicated to wireless communication functions and one processor dedicated to running other applications. Typically, software applications may be stored on non-transitory processor-readable medium, such as a disk drive 1703, before the instructions are accessed and loaded into the processor. The processor 1701 may include internal memory sufficient to store the application software instructions.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods may be substituted for or combined with one or more operations of the methods.

Implementation examples are described in the following paragraphs. While some of the following implementation examples are described in terms of example methods, further example implementations may include: the example methods discussed in the following paragraphs implemented by a computing device comprising a processor configured with processor-executable instructions to perform operations of the methods of the following implementation examples; the example methods discussed in the following paragraphs implemented by a computing device comprising means for performing functions of the methods of the following implementation examples; and the example methods discussed in the following paragraphs may be implemented as a non-transitory processor-readable storage medium having stored thereon processor-executable instructions configured to cause a processor in a computing device to perform the operations of the methods of the following implementation examples.

Example 1. A method implemented on a computing device for selecting a neural network for a hardware configuration, including using an accuracy predictor to select from a search space a neural network including a first plurality of the blockwise knowledge distillation trained search blocks, in which the accuracy predictor is built using blockwise knowledge distillation trained search blocks that were trained from the search space.

Example 2. The method of example 1, further including selecting a second plurality of the blockwise knowledge distillation trained search blocks based on criteria of predicted accuracy using the accuracy predictor and a cost function for implementing the second plurality of the blockwise knowledge distillation trained search blocks.

Example 3. The method of example 2, in which selecting the second plurality of the blockwise knowledge distillation trained search blocks may include using an evolutionary search to select the second plurality of the blockwise knowledge distillation trained search blocks.

Example 4. The method of example 3, in which the second plurality of the blockwise knowledge distillation trained search blocks are Pareto-optimal blockwise knowledge distillation trained search blocks.

Example 5. The method of any of examples 1-4, in which using the accuracy predictor to select from the search space the neural network includes selecting the first plurality of the blockwise knowledge distillation trained search blocks using a scenario-aware search to select the first plurality of the blockwise knowledge distillation trained search blocks.

Example 6. The method of any of examples 1-5, including: initializing the first plurality of the blockwise knowledge distillation trained search blocks using weights of the blockwise knowledge distillation trained search blocks; and fine-tuning the neural network using knowledge distillation.

Example 7. The method of examples 1-6, including: selecting a sub-set of neural networks of the search space, in which each neural network of the sub-set of neural networks may include blockwise knowledge distillation trained search blocks of the generated blockwise knowledge distillation trained search blocks; initializing the blockwise knowledge distillation trained search blocks of the sub-set of neural networks using weights of the blockwise knowledge distillation trained search blocks, and fine-tuning the sub-set of neural networks using knowledge distillation.

Example 8. The method of example 7, including: extracting a quality metric by using blockwise knowledge distillation to train the neural network blocks from the search space and extracting a target by fine-tuning the sub-set of neural networks using knowledge distillation, in which the accuracy predictor is built using a linear regression model from the quality metric to the target.

Example 9. The method of any of examples 1-8, in which using the accuracy predictor to select from the search space the neural network includes selecting the neural network of the search space based on a search of the blockwise knowledge distillation trained search blocks using a criterion of predicted accuracy using the accuracy predictor and a cost function for implementing blockwise knowledge distillation trained search blocks of the neural network, the method further including: initializing the second plurality of the blockwise knowledge distillation trained search blocks using weights of the blockwise knowledge distillation trained search blocks; and fine-tuning the neural network using knowledge distillation, to generate a distilled neural network.

Example 10. The method of any of examples 1-9, including: using blockwise knowledge distillation to train neural network blocks from an extended search space to generate blockwise knowledge distillation trained search blocks and quality metrics, using the accuracy predictor to predict accuracy of the extended search space, in which the accuracy predictor is built for the search space different from the extended search space.

Example 11. The method of any of claims 1-10, further including using blockwise knowledge distillation to train neural network blocks from a search space to generate the blockwise knowledge distillation trained search blocks.

The foregoing method descriptions and the process flow diagrams are provided merely as illustrative examples and are not intended to require or imply that the operations of various embodiments may be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, functionality components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A method implemented on a computing device for selecting a neural network for a hardware configuration, comprising:
using an accuracy predictor to select from a search space a neural network comprising a first plurality of the blockwise knowledge distillation trained search blocks, wherein the accuracy predictor is built using blockwise knowledge distillation trained search blocks that were trained from the search space.

2. The method of claim 1, further comprising selecting a second plurality of the blockwise knowledge distillation trained search blocks based on criteria of predicted accuracy using the accuracy predictor and a cost function for implementing the second plurality of the blockwise knowledge distillation trained search blocks.

3. The method of claim 2, wherein selecting the second plurality of the blockwise knowledge distillation trained search blocks comprises using an evolutionary search to select the second plurality of the blockwise knowledge distillation trained search blocks.

4. The method of claim 3, wherein the second plurality of the blockwise knowledge distillation trained search blocks are Pareto-optimal blockwise knowledge distillation trained search blocks.

5. The method of claim 1, wherein using the accuracy predictor to select from the search space the neural network comprises selecting the first plurality of the blockwise knowledge distillation trained search blocks using a scenario-aware search to select the first plurality of the blockwise knowledge distillation trained search blocks.

6. The method of claim 1, further comprising:
initializing the first plurality of the blockwise knowledge distillation trained search blocks using weights of the blockwise knowledge distillation trained search blocks; and
fine-tuning the neural network using knowledge distillation.

7. The method of claim 1, further comprising:
selecting a sub-set of neural networks of the search space, wherein each neural network of the sub-set of neural networks comprises blockwise knowledge distillation trained search blocks of the generated blockwise knowledge distillation trained search blocks;
initializing the blockwise knowledge distillation trained search blocks of the sub-set of neural networks using weights of the blockwise knowledge distillation trained search blocks; and
fine-tuning the sub-set of neural networks using knowledge distillation.

8. The method of claim 7, further comprising:
extracting a quality metric by using blockwise knowledge distillation to train the neural network blocks from the search space; and
extracting a target by fine-tuning the sub-set of neural networks using knowledge distillation,
wherein the accuracy predictor is built using a linear regression model from the quality metric to the target.

9. The method of claim 1, wherein:
using the accuracy predictor to select from the search space the neural network comprises selecting the neural network of the search space based on a search of the blockwise knowledge distillation trained search blocks using a criterion of predicted accuracy using the accuracy predictor and a cost function for implementing blockwise knowledge distillation trained search blocks of the neural network and
the method further comprises:
initializing the second plurality of the blockwise knowledge distillation trained search blocks using weights of the blockwise knowledge distillation trained search blocks; and
fine-tuning the neural network using knowledge distillation, to generate a distilled neural network.

10. The method of claim 1, further comprising:
using blockwise knowledge distillation to train neural network blocks from an extended search space to generate blockwise knowledge distillation trained search blocks and quality metrics; and
using the accuracy predictor to predict accuracy of the extended search space, wherein the accuracy predictor is built for the search space different from the extended search space.

11. A computing device, comprising a processor configured with processor-executable instructions to perform operations comprising:
using an accuracy predictor to select from a search space a neural network comprising a first plurality of the blockwise knowledge distillation trained search blocks, wherein the accuracy predictor is built using blockwise knowledge distillation trained search blocks that were trained from the search space.

12. The computing device of claim 11, wherein the processor is configured with processor-executable instructions to perform operations further comprising selecting a second plurality of the blockwise knowledge distillation trained search blocks based on criteria of predicted accuracy using the accuracy predictor and a cost function for implementing the second plurality of the blockwise knowledge distillation trained search blocks.

13. The computing device of claim 12, wherein the processor is configured with processor-executable instructions to perform operations such that selecting the second plurality of the blockwise knowledge distillation trained search blocks comprises using an evolutionary search to select the second plurality of the blockwise knowledge distillation trained search blocks.

14. The computing device of claim 13, wherein the processor is configured with processor-executable instructions to perform operations such that the second plurality of the blockwise knowledge distillation trained search blocks are Pareto-optimal blockwise knowledge distillation trained search blocks.

15. The computing device of claim 11, wherein the processor is configured with processor-executable instructions to perform operations such that using the accuracy predictor to select from the search space the neural network comprises selecting the first plurality of the blockwise knowledge distillation trained search blocks using a scenario-aware search to select the first plurality of the blockwise knowledge distillation trained search blocks.

16. The computing device of claim 11, wherein the processor is configured with processor-executable instructions to perform operations further comprising:
initializing the first plurality of the blockwise knowledge distillation trained search blocks using weights of the blockwise knowledge distillation trained search blocks; and
fine-tuning the neural network using knowledge distillation.

17. The computing device of claim 11, wherein the processor is configured with processor-executable instructions to perform operations further comprising:
selecting a sub-set of neural networks of the search space, wherein each neural network of the sub-set of neural networks comprises blockwise knowledge distillation trained search blocks of the generated blockwise knowledge distillation trained search blocks;
initializing the blockwise knowledge distillation trained search blocks of the sub-set of neural networks using weights of the blockwise knowledge distillation trained search blocks; and
fine-tuning the sub-set of neural networks using knowledge distillation.

18. The computing device of claim 17, wherein the processor is configured with processor-executable instructions to perform operations further comprising:
extracting a quality metric by using blockwise knowledge distillation to train the neural network blocks from the search space; and
extracting a target by fine-tuning the sub-set of neural networks using knowledge distillation,
wherein the accuracy predictor is built using a linear regression model from the quality metric to the target.

19. The computing device of claim 11, wherein:
the processor is configured with processor-executable instructions to perform operations such that using the accuracy predictor to select from the search space the neural network comprises selecting the neural network of the search space based on a search of the blockwise knowledge distillation trained search blocks using a criterion of predicted accuracy using the accuracy predictor and a cost function for implementing blockwise knowledge distillation trained search blocks of the neural network; and
the processor is configured with processor-executable instructions to perform operations further comprising:
initializing the second plurality of the blockwise knowledge distillation trained search blocks using weights of the blockwise knowledge distillation trained search blocks; and
fine-tuning the neural network using knowledge distillation, to generate a distilled neural network.

20. The computing device of claim 11, wherein the processor is configured with processor-executable instructions to perform operations further comprising:
using blockwise knowledge distillation to train neural network blocks from an extended search space to generate blockwise knowledge distillation trained search blocks and quality metrics; and
using the accuracy predictor to predict accuracy of the extended search space, wherein the accuracy predictor is built for the search space different from the extended search space.

21. A non-transitory, processor-readable medium having stored thereon processor-executable instructions configured to cause a processor to perform operations comprising:
using an accuracy predictor to select from a search space a neural network comprising a first plurality of the blockwise knowledge distillation trained search blocks, wherein the accuracy predictor is built using blockwise knowledge distillation trained search blocks that were trained from the search space.

22. A computing device, comprising:
means for using an accuracy predictor to select from a search space a neural network comprising a first plurality of the blockwise knowledge distillation trained search blocks, wherein the accuracy predictor is built using blockwise knowledge distillation trained search blocks that were trained from the search space.

23. The computing device of claim 22, further comprising means for selecting a second plurality of the blockwise knowledge distillation trained search blocks based on criteria of predicted accuracy using the accuracy predictor and a cost function for implementing the second plurality of the blockwise knowledge distillation trained search blocks.

24. The computing device of claim 23, wherein means for selecting the second plurality of the blockwise knowledge distillation trained search blocks comprises means for using an evolutionary search to select the second plurality of the blockwise knowledge distillation trained search blocks.

25. The computing device of claim 22, wherein means for using the accuracy predictor to select from the search space the neural network comprises means for selecting the first plurality of the blockwise knowledge distillation trained search blocks using a scenario-aware search to select the first plurality of the blockwise knowledge distillation trained search blocks.

26. The computing device of claim 22, further comprising:
means for initializing the first plurality of the blockwise knowledge distillation trained search blocks using weights of the blockwise knowledge distillation trained search blocks; and
means for fine-tuning the neural network using knowledge distillation.

27. The computing device of claim 22, further comprising:
means for selecting a sub-set of neural networks of the search space, wherein each neural network of the sub-set of neural networks comprises blockwise knowledge distillation trained search blocks of the generated blockwise knowledge distillation trained search blocks;
means for initializing the blockwise knowledge distillation trained search blocks of the sub-set of neural networks using weights of the blockwise knowledge distillation trained search blocks; and
means for fine-tuning the sub-set of neural networks using knowledge distillation.

28. The computing device of claim 27, further comprising:
means for extracting a quality metric by using blockwise knowledge distillation to train the neural network blocks from the search space; and
means for extracting a target by fine-tuning the sub-set of neural networks using knowledge distillation,
wherein the accuracy predictor is built using a linear regression model from the quality metric to the target.

29. The computing device of claim 22, wherein means for using the accuracy predictor to select from the search space the neural network comprises means for selecting the neural network of the search space based on a search of the blockwise knowledge distillation trained search blocks using a criterion of predicted accuracy using the accuracy predictor and a cost function for implementing blockwise knowledge distillation trained search blocks of the neural network,
the computing device further comprising:
means for initializing the second plurality of the blockwise knowledge distillation trained search blocks using weights of the blockwise knowledge distillation trained search blocks; and
means for fine-tuning the neural network using knowledge distillation, to generate a distilled neural network.

30. The computing device of claim 22, further comprising:
means for using blockwise knowledge distillation to train neural network blocks from an extended search space to generate blockwise knowledge distillation trained search blocks and quality metrics;
means for using the accuracy predictor to predict accuracy of the extended search space, wherein the accuracy predictor is built for the search space different from the extended search space.
